(19) United States
(12) Patent Application Publication
(10) Pub. No.: US 2025/0386292 A1
(43) Pub. Date: Dec. 18, 2025

(54) ENHANCED MULTI-LINK BASED DYNAMIC POWER SAVING

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 19/195,500

(22) Filed: Apr. 30, 2025

Related U.S. Application Data
(60) Provisional application No. 63/659,998, filed on Jun. 14, 2024.

(51) Int. Cl. H04W 52/02; H04L 1/00; H04W 84/12

(52) U.S. Cl. CPC H04W 52/0219; H04L 1/0003; H04W 52/0261; H04W 84/12

(57) ABSTRACT

A multiple link device (MLD) for performing a wireless communications protocol to provide dynamic power saving (PS) on a wireless local area network (WLAN). The Active state (non-dozing) comprises both a full capability higher powered state, and a lower powered state in which it has less capability. Wherein stations of an MLD can be directed to listen using the lower power active mode; yet a transition to the higher power active mode can be made when the need arises for transmitting frames with another MLD.

### CROSS-REFERENCE TO RELATED APPLICATIONS

This application claims priority to, and the benefit of, U.S. provisional patent application Ser. No. 63/659,998 filed on Jun. 14, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to Power Saving (PS) for Enhanced Multi-Link (EML) communications, and more particularly to dividing the active mode into high and low capability modes to increase overall throughput while meeting power saving objectives.

### 2. Background Discussion

Existing systems, such as under IEEE 802.11bn provide a level of power saving when the station enters a state of being asleep, which is called a dozing state, or ‘doze’. Although this mechanism can provide significant power savings; power usage can be further optimized.

Accordingly, a need exists for more efficient Power Saving (PS) mechanisms. The present disclosure fulfills that need and provides additional benefits over existing systems.

### BRIEF SUMMARY

Ultra-High Reliability (UHR) operations are described in which Multiple-Link Devices (MLDs) and their associated Stations (STAs) are configured for communicating over a network with improved power savings. In existing systems power savings are achieved by switching from the active state (mode) to a dozing state (asleep).

In this disclosure the active state is configured for managing both a fully powered state in which it can transmit and/or receive in a higher powered active state (higher power active mode), and a lower powered active state (lower power active mode) in which it is capable of only listening. Under this protocol one or more of the STAs of an MLD are able to listen on the enabled EML(SR/MR) link(s) using the lower power active mode. The STAs are able to transition to the higher power active mode for transmitting frames, or for using extended capabilities over what is available in the lower power active mode. It will be noted that in a preferred embodiment the lower power active mode provides more limited characteristics, such as in regard to bandwidth, number of streams, encoding, and other elements, which for example may require higher power levels.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a high level architecture for AP MLDs having multiple affiliated APs according to at least one embodiment of the present disclosure.

FIG. 4 is a network topology diagram according to at least one embodiment of the present disclosure.

FIG. 5 is a block diagram of an Ultra-High Reliability (UHR) AP MLD having a single EML Single Radio (EMLSR), according to at least one embodiment of the present disclosure.

FIG. 6 is a block diagram of an Ultra-High Reliability (UHR) AP MLD having a single EML Multiple Radio (EMLMR), according to at least one embodiment of the present disclosure.

FIG. 7 is a block diagram of an Ultra-High Reliability (UHR) AP MLD having multiple EML Single Radios (EMLSRs), and optional isolation between the radios, according to at least one embodiment of the present disclosure.

FIG. 8 is a block diagram of an Ultra-High Reliability (UHR) AP MLD having a multiple EML Multiple Radios (EMLMRs), and optional isolation between the radios, according to at least one embodiment of the present disclosure.

FIG. 9 is a data field diagram of an Initial Control Frame (ICF) according to at least one embodiment of the present disclosure.

FIG. 10A and FIG. 10B is a communications diagram of an EMLSR-based PS on the non-AP STA MLD side, according to at least one embodiment of the present disclosure.

FIG. 11A and FIG. 11B is a communications diagram of an EMLSR-based PS on non-AP STA MLD side with temporary dozing EMLSR link(s), according to at least one embodiment of the present disclosure.

FIG. 12A and FIG. 12B is a communications diagram of an EMLMR-based PS on the non-AP STA MLD side, according to at least one embodiment of the present disclosure.

FIG. 13A and FIG. 13B is a communications diagram of EMLMR-based PS on the non-AP STA MLD side with temporary dozing EMLMR link(s), according to at least one embodiment of the present disclosure.

FIG. 14A and FIG. 14B is a communications diagram of EMLSR-based PS on the AP MLD side, according to at least one embodiment of the present disclosure.

FIG. 15A and FIG. 15B is a communications diagram of EMLSR-based PS on the AP MLD side with temporary dozing EMLSR link(s), according to at least one embodiment of the present disclosure.

FIG. 16A through FIG. 16C is a communications diagram of EMLMR-based PS on the AP MLD side, according to at least one embodiment of the present disclosure.

FIG. 17A through FIG. 17C is a communications diagram of an EMLMR-based PS on the AP MLD side with temporarily dozing EMLMR link(s), according to at least one embodiment of the present disclosure.

FIG. 18A and FIG. 18B is a communications diagram of EMLSR-based PS on the AP MLD side with the radios being Radio-Frequency (RF) isolated from one another, according to at least one embodiment of the present disclosure.

FIG. 19A through FIG. 19C is a communications diagram of EMLMR-based PS on the AP MLD side with the radios being Radio-Frequency (RF) isolated from one another according to at least one embodiment of the present disclosure.

### DETAILED DESCRIPTION

### 1. Introduction

Power Saving (PS) is one research topic that has currently been discussed in the IEEE 802.11 Task Group for 802.11bn (TGbn), which defines a power saving mode for a station (STA) that is an Ultra High Reliability (UHR) Mobile Access Point (AP) or a UHR non-AP STA, in which the STA is capable of transitioning from a lower capability mode to a higher capability mode upon reception of an initial control frame. The lower capability mode refers, for example, to that of having a 20 MHz Bandwidth (BW), one Spatial Stream (SS), limited data rates, a PPDU format (Physical Layer Convergence Protocol (PLCP) Protocol Data Unit (PPDU) format). The higher capability mode refers, for example, to an operating Bandwidth (BW), a Number of Spatial Streams (NSS) and multiple Modulation and Coding Sets (MCSs), with at least one value of these parameters that indicates higher capability than that which is utilized in the lower power capability mode. Although many aspects regarding control and scope have not been determined.

TGbn has also defined a cross-link power saving signaling mechanism, which allows a non-AP MLD to indicate to its associated AP MLD that it supports the mechanism in a frame sent on one enabled link, and indicates the power management mode for one or more of its affiliated non-AP STAs. It is unknown whether support for this mechanism will be mandatory or optional.

Since devices listening in the active state contribute to the majority of energy consuming operations, properly managing this area is necessary in providing a more efficient PS mechanism.

Various PS designs can be engineered taking into consideration different perspectives, such as Spatial Multiplexing (SM) PS as an (SMPS)-based, Enhanced Multi-Link Single-Radio (EMLSR)-based PS, Intra-PPDU PS, TWT-based PS, Periodical scheduled time window and PS with cross-link indication, which can also be classified into dynamic PS, scheduled PS, unscheduled PS.

The present disclosure primarily focuses on the dynamic PS mechanisms which are designed for UHR AP and UHR non-AP devices.

### 2. Existing Power Saving (PS) Mechanisms

Different PS mechanisms are defined in the pre-802.11bn specifications and are briefly summarized as follows:

(A) Power management modes: a non-AP STA can be in one of two power management modes including the active mode and the power save (PS) mode.

(A)(1) For the power save mode, the STA can receive and transmit frames at any time it is in the active (awake) state. A non-HE STA remains in the awake state. An HE STA remains in the awake state unless the STA is unavailable. A STA that is unavailable is not capable of receiving PPDUs.

(A)(2) For the PS mode, the STA enters the awake state to receive or transmit frames. The STA remains in the doze state otherwise. A STA in PS mode can be in one of two power states: (i) awake with the STA being fully powered, and (ii) doze state in which the STA is not able to transmit or receive (IEEE 802.11ba) non-WUR PPDUs and consumes very low power.

(A)(3) A STA operating in active mode shall have its receiver activated continuously, (802.11ax) unless the STA is allowed to be temporarily unavailable through an opportunistic power saving mechanism or through the intra-PPDU power saving mechanism, or during Target Wake Time (TWT) Service Period (SP); such STAs do not need to interpret the Traffic Indication Map (TIM) elements in Beacon frames.

(B) Non-AP STA PS: To change power management modes a STA shall inform the AP by completing a successful frame exchange that is initiated by the STA. This frame exchange sequence shall include a Management frame, Extension frame or Data frame from the STA, and an Ack or a BlockAck frame from the AP. The Power Management subfield(s) in the Frame Control field of the frame(s) sent by the STA in this exchange indicates the power management mode that the STA shall adopt upon successful completion of the frame exchange sequence, except where the Power Management subfield is reserved. A non-AP STA shall not change power management mode using a frame exchange sequence that does not receive an Ack or BlockAck frame from the AP, or using a BlockAckReq frame.

(C) WNM (Wireless Network Management) mode: enables an extended power save mode for non-AP STAs in which a non-AP STA does not need to listen for every Delivery Traffic Indication Map (DTIM) Beacon frame and need not perform Group Temporal Key (GTK)/Integrity Group Temporal Key (IGTK)/Beacon Integrity Group Temporal Key (BIGTK) updates. A STA may use both Wireless Network Management (WNM) sleep mode and PS mode simultaneously.

(D) APSD (Automatic Power Save Delivery): a STA in APSD PS mode sends a frame with the Power Management (PM) subfield set to 1 in the Frame Control field, causing AP buffering Data. Quality of Service (QoS) STAs use the PM subfield in the Frame Control field of a frame to indicate whether it is in the active or Power Saving (PS) mode. As APSD is a mechanism for the delivery of Bufferable Units (BUs) to power saving STAs, the frames transmitted by a STA in PS mode that is using APSD having the PM subfield in the Frame Control field set to 1, thereby causing buffering to take place at the AP. APSD defines two delivery mechanisms, unscheduled APSD (U-APSD) and scheduled APSD (S-APSD).

(D)(1) If there is no Unscheduled-APSD (U-APSD) Service Period (SP) in progress, the unscheduled SP begins when the AP receives a trigger frame from a STA, which is a QoS Data or QoS Null frame using an Access Category (AC) the STA has configured to be trigger-enabled. An unscheduled SP ends after the AP has attempted to transmit at least one BU using a delivery-enabled AC and destined for the STA, but no more than the number indicated in the Max SP Length field of the QoS Capability element of the STA's (Re)Association Request frame if the field has a nonzero value. The last frame sent during the SP has the EOSP subfield set to 1.

(D)(2) A scheduled SP starts at fixed intervals of time and begins at the scheduled wakeup time that corresponds to the SI and the service start time, indicated in the Schedule element sent in response to a Traffic Specification (TSPEC) or Group Cast with Retries (GCR) Request.

(D)(3) APSD shall be used only to deliver individually addressed BUs and GCR-SP BUs to a STA.

(D)(4) A STA using APSD shall operate as follows to receive a BU from the AP: If a scheduled SP has been set up, the STA wakes up at its scheduled start time. If the STA is initiating an unscheduled SP, the STA wakes up and transmits a trigger frame to the AP. The STA shall remain awake until it receives a QoS Data frame or QoS Null frame addressed to it, with the End of Service Period (EOSP) subfield equal to 1. The STA may send additional PS-Poll frames if the More Data subfield is 1 in a downlink individually addressed MAC Protocol Data Unit (MPDU) containing all or part of a BU that does not use a delivery-enabled AC. The STA may send additional trigger frames if the More Data subfield is 1 in a downlink individually addressed MPDU containing all or part of a BU that uses a delivery-enabled AC.

(E) Non-APSD (Automatic Power Save Delivery) PS mode: In a Basic Service Set (BSS) operating under the Distributed Coordination Function (DCF) or Enhanced Distributed Channel Access (EDCA), upon determining that a BU is currently buffered in the AP, a STA operating in the normal (non-APSD) PS mode transmits a Null Data Packet (NDP) PS-Poll frame to the AP, which responds with the corresponding buffered BU immediately, or acknowledges the (NDP) PS-Poll frame and responds with the corresponding BU at a later time.

(F) PSMP (Power Saving Multi-Poll): An AP transmits a PSMP frame containing a schedule only for STAs that are awake. A STA with an established PSMP session shall be awake at the start of the session's SP and shall remain awake until the end of the SP unless permitted to return to sleep. The AP may signal the end of the SP for all awake associated PSMP-capable STAs by setting the More PSMP field to 0 or by sending CF-End frame instead of the next PSMP frame.

(G) Opportunistic Power Save (OPS): The objective is to allow OPS non-AP STAs to be unavailable or to be in doze state so that they can save power for a defined period. OPS has two modes: aperiodic and periodic.

(G)(1) In the aperiodic mode, an OPS AP sends an OPS frame or a Fast Initial Link Setup (FILS) Discovery frame at any time to provide the scheduling information for all OPS non-AP STAs for the OPS period. Based on this information, the OPS non-AP STAs that are in the active mode may be unavailable during the OPS period, and the OPS non-AP STAs that are in PS mode may be in doze state during the OPS period. The TIM element is encoded specifically in order to identify which STAs are not scheduled during the OPS period.

(G)(2) In the periodic mode, an OPS AP splits a beacon interval into several periodic broadcast TWT SPs and provides, at the beginning of each SP, the scheduling information for all OPS non-AP STAs. Based on this information, the OPS non-AP STAs that are in the active mode may be unavailable until the next TWT SP, and the OPS non-AP STAs that are in the PS mode may be in the doze state until the next TWT SP. To enable periodic opportunistic power saving, an OPS AP shall include a TWT element in beacons to set a periodic Broadcast TWT SP with the following information: The Broadcast TWT Recommendation field set to a value of 3 and The Broadcast TWT ID subfield set to a value of 0.

(H) Intra-PPDU power save for non-AP HE STAs: Intra-PPDU power save is the power save mechanism for an HE STA to enter the doze state or become unavailable until the end of a received PPDU that is identified as an intra-BSS PPDU. The STA can enter the doze state if it is in PS mode and can become unavailable if it is in active mode. A non-AP HE STA that is in intra-PPDU power save mode and has entered doze state or has become unavailable shall continue to operate its Network Allocation Vector (NAV) timers and to consider the medium busy and shall transition to the awake state at the end of the PPDU. A non-AP HE STA that is in intra-PPDU power save mode may discard an inter-BSS PPDU until the end of the PPDU.

(I) SM (Spatial Multiplexing) PS: The SM power save feature allows a non-AP HT STA or a non-AP and non-PCP EDMG STA in an infrastructure BSS or PBSS to operate with only one active receive chain for a significant portion of time. A STA needs to transmit an SM power save frame to enter the SM power save mode. In dynamic SM power save mode, the non-AP STA uses a single RF chain for listening, and switches to the multiple receive chain mode when it receives a frame addressed to it. The frame exchange sequence shall start with a single-spatial stream individually addressed frame that is not a Trigger frame, that requires an immediate response and that is addressed to the STA in dynamic SM power save mode. The STA shall be capable of receiving a PPDU that is sent using more than one spatial stream with a SIFS after the end of the PPDU it sends as the immediate response. The STA may switch back to the single receive chain mode immediately after the end of the frame exchange sequence.

(J) EMLSR: The EMLSR operation allows a non-AP MLD with multiple receive chains to listen on one or more EMLSR links when the corresponding non-AP STA(s) affiliated with the non-AP MLD is (are) in the awake state, for an initial Control frame sent by an AP affiliated with an AP MLD in a non-HT (duplicate) PPDU and then participate in frame exchanges on the link on which the initial Control frame was received.

(K) EMLMR: The enhanced multi-link multi-radio (EMLMR) operation allows a non-AP MLD with multiple radios on multiple links to listen to a set of links as defined below for an initial frame sent by an AP affiliated with an AP MLD, followed by frame exchanges that satisfy the MCS and number of spatial streams (NSS) capabilities in the EMLMR mode on the link on which the initial frame was received. In this case the initial frame is transmitted in a PPDU whose NSS satisfies the receiving STA's capabilities. A non-AP MLD supporting the EMLMR Option shall indicate the number of spatial streams NSS that it supports for reception and transmission on any EMLMR link after responding to the initial frame in the EMLMR Supported MCS and NSS Set subfield of the EML Control field of the EML Operating Mode Notification frame.

### 3. Problem Statement

In pre-802.11bn PS design, the mechanisms are basically all for non-AP devices, a new PS mechanism for AP in 11bn is needed.

In current EML(SR/MR) mechanisms as defined in 11be, the EHT STA could only be enabled to operate with some low MCSs, and with single NSS or multiple NSS in EMLSR or EMLMR, respectively. However, the EHT STA still needs to listen over all operation bandwidth (BW) and links. It would be more energy efficient if the STA could only listen to a narrower BW, e.g., 20 MHz, on one or each of EML(SR/MR) enabled links, rather than the whole BW.

The current EML(SR/MR) operation as defined in 802.11be only applies to non-AP MLDs; and it will be appreciated that designing EML(SR/MR)-based power saving mechanisms for an AP MLD is more challenging.

Besides, when a device transitions from a lower capability mode to a higher capability mode, there could be insufficient time between the exchange of the initial control frame (ICF) and ICF response frames, which is SIFS, for the device to (a) reconfigure the radio to serve high capability operation and to (b) check CCA on the wider BW.

### 4. Objects of the Present Disclosure

The present disclosure describes a number of different objects and operations for an EML-based Power Saving (PS) protocol providing EMLSR-based and EMLMR-based PS mechanisms for both non-AP MLDs and AP MLDs. This disclosure also provides a mechanism for resolving the transition delay issue, whereby a device can more readily switch from lower capability mode to higher capability mode.

### 5. Communication Hardware Embodiments

### 5.1. Communication Station (STA and MLD) Hardware

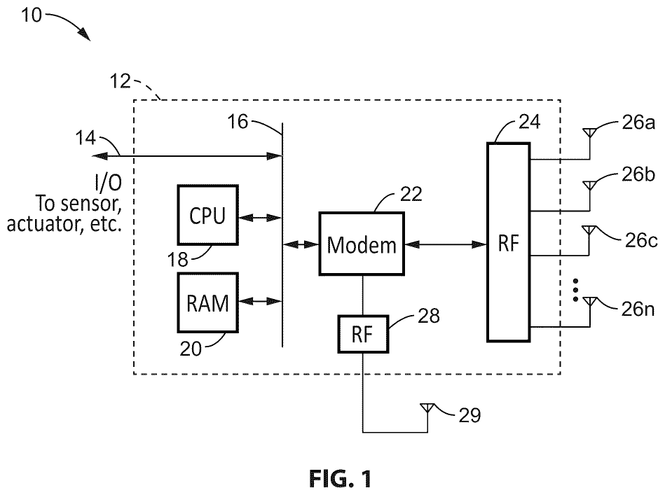

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an Access Point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

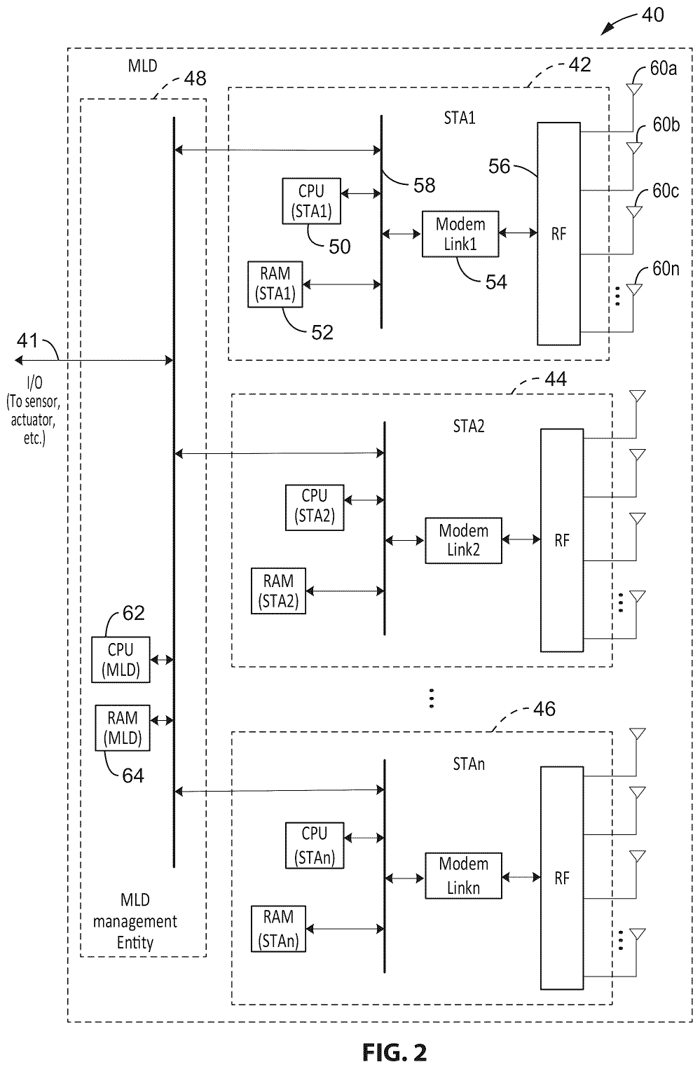

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 5.2. Backhaul Architecture for AP MLDs

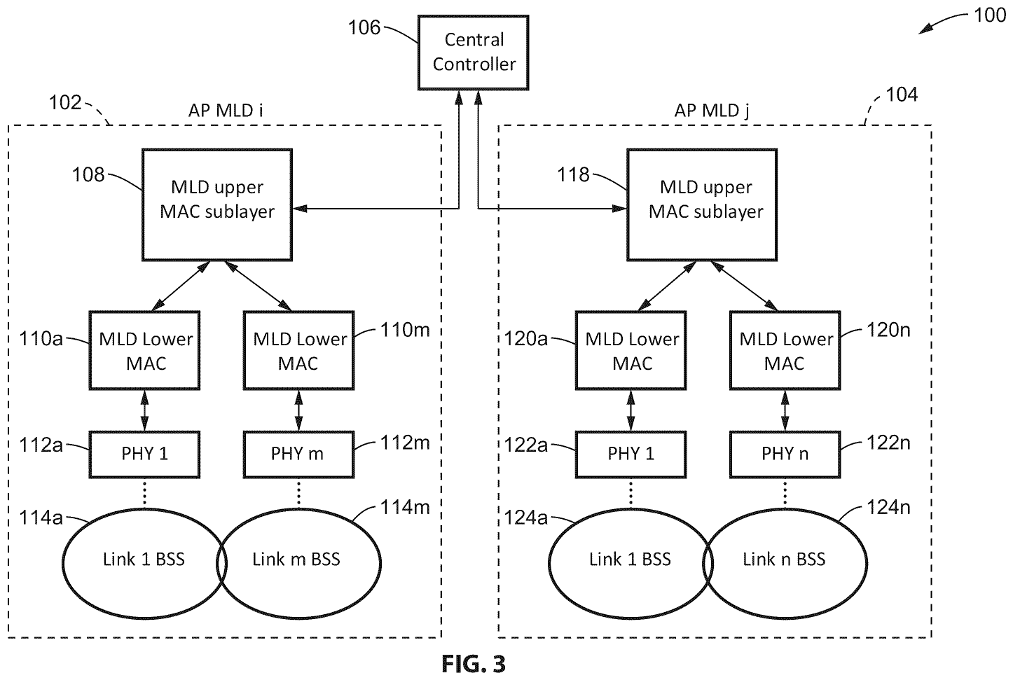

FIG. 3 illustrates an example embodiment 100 of a high level architecture for AP MLDs having multiple affiliated APs (e.g., 102, 104) connected to a central controller 106. The proposed enhancements provided in this disclosure may have a backhaul connection between cooperating APs. The backhaul architecture has one central controller connected with multiple AP MLDs through wired and/or wireless backhauls and each AP MLD 102, 104 includes the MLD upper MAC sublayer 108, 118, and one or more MLD lower MAC sublayers, one for each link 110a-110m, 120a-120n. In the 802.11be specification, the MLD upper MAC sublayer performs functionalities that are common across all links, and each MLD lower MAC sublayer performs functions that are local to each link. For example, some link management related functions, such as TID-to-Link mapping and Link Merging, are placed in the MLD upper MAC sublayer. In 802.11bn, certain functionalities originally in the MLD upper MAC sublayer as specified in 802.11be may be suitably placed in the central controller, so as to be able to enhance seamless roaming with limited or no interruptions of service. The present disclosure considers link management functionalities placed in the central controller and/or the MLD upper MAC sublayers. It should be noted that the figure also depicts the connections to the Physical layer (PHY) 112a-112m, 122a-122n, and then down to the Link layers 114a-114m, 124a-124n.

### 6. Example Network Topologies

It should be appreciated that the following topology is provided for the purpose of exemplifying network operations, and is not to be interpreted as describing limitations on the topologies within which the teachings of the present disclosure can operate.

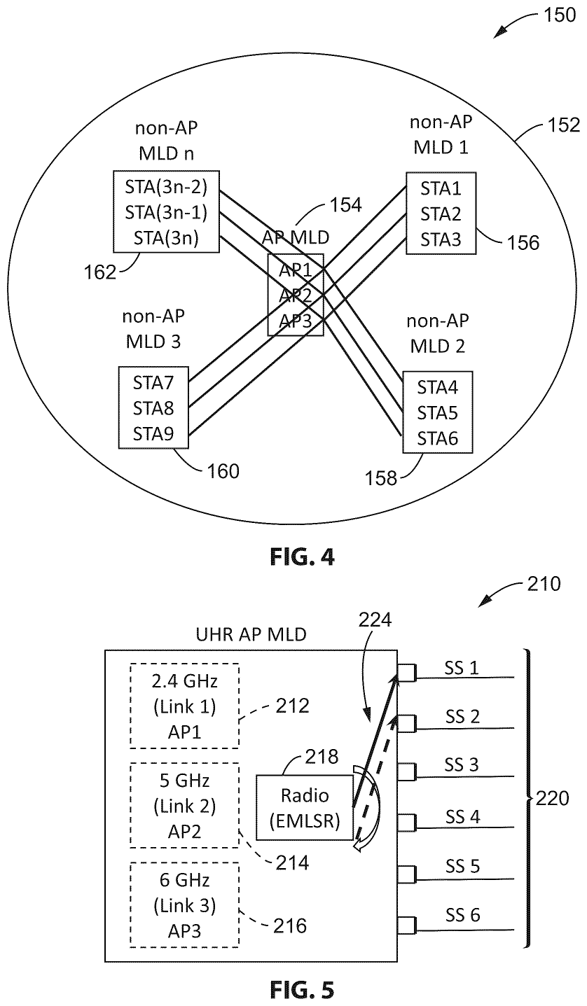

FIG. 4 illustrates a network topology 150 in which the AP MLD 154 shown with range 152 is associated with ‘n’ number of non-AP MLDs. In this example there are shown three APs (e.g., AP1, AP2 and AP3) affiliated with the AP MLD and each non-AP MLD 156, 158, 160 162 are exemplified with three non-AP STAs affiliated with it. In these examples, the AP MLD and the non-AP MLDs have established link setup over three links, which in these examples are for 2.4 GHz, 5 GHz and 6 GHz links.

### 7. Dynamic PS (DPS) Protocol Design

7.1. EMLSR-based PS on non-AP STA MLD Side

(1) The EML Operating Mode Notification frame, which is used to enable or disable EMLSR mode over the EMLSR Link(s) as defined in Draft P802.11be_D6.0 is herein described as being revised according to the present disclosure to supply the needs of STA(s) affiliated with the non-AP MLD operating on the enabled EMLSR link(s) toward allowing them to listen in a lower capability mode.

(1)(a) The lower capability mode in one instance refers to a lower level of capability having for example a 20 MHz Bandwidth (BW), one SS, limited data rates, and a PPDU format. (i) The operation of the lower capability mode includes Clear Channel Assessment (CCA) and receiving the Initial Control Frame (ICF) of the frame exchanges that are initiated by the associated AP MLD. (ii) The operation of the lower capability mode includes CCA and transmitting for example a short control frame by the non-AP MLD.

(1)(b) The higher capability mode refers to, for instance having an operating BW, NSS and MCSs, subject to at least one value which indicates a higher capability than that in the lower power capability mode. (i) The operation of the higher capability mode includes CCA and transmitting the (un-solicited) initial Control Response (ICR) frame, DATA frame and Ack frame that are transmitted to, or exchanged with, the AP MLD.

(2) After the non-AP MLD starts operating in the EMLSR mode on the EMLSR link(s), the non-AP STA(s) operating on the enabled EMLSR link(s) should operate with the lower capability mode at the same time as the start time of the EMLSR mode is enabled on the corresponding EMLSR link(s).

(3) The lower capability mode of the non-AP STA(s) operating on the enabled EMLSR link(s) should be disabled at the same time as the EMLSR mode is disabled over the corresponding EMLSR link(s).

(4) An AP affiliated with the AP MLD that initiates frame exchanges that are neither group addressed Data nor group addressed Management frames with the non-AP MLD on one of the EMLSR links shall begin the frame exchanges by transmitting the ICF to the non-AP MLD with the limitations specified below:

(4)(a) The ICF frame of the frame exchanges shall be sent in the non-HT PPDU or non-HT duplicated PPDU format using a rate of X Mb/s, where X could be for example 6, 12, or 24, such as for example over the whole operating BW.

(4)(b) Padding should be incorporated in the ICF frame to ensure that the non-AP STA affiliated with a non-AP MLD that is listening with the lower capability mode and receives the ICF over the narrow BW has sufficient time to complete the CCA over the operating BW before sending a response to the AP MLD when receiving the ICR frame. (i) A new intermediate Frame Check Sequence (FCS) field is to be carried in the ICF frames and located before the padding. In this case, the non-AP STA that is listening when using the lower capability mode and receives the ICF over the narrow BW does not need to wait until it decodes the FCS in the end of the ICF frame to start the transition. Instead, after decoding the intermediate FCS field of the ICF frame and identifying the successful reception of the ICF frame, the recipient non-AP STA can start a transition from the lower capability mode to higher capability mode.

(4)(c) The ICF frame may comprise different types of frames, for example a MU-RTS Trigger frame or a BSRP Trigger frame.

(4)(d) The ICR frame may comprise different types of frames, for example a CTS frame or a BSR frame.

(5) A non-AP STA affiliated with a non-AP MLD that is listening with the lower capability mode on the narrow BW, e.g., 20 MHz, may initiate CCA over the wider operating BW without receiving any ICF frame from its associated AP MLD, and can transmit an un-solicited ICR frame to the affiliated AP on the wider operating BW after identifying CCA idle. The un-solicited ICR frame can be configured to either request, or to not request, an immediate response frame from the recipients.

(6) A non-AP STA affiliated with a non-AP MLD that is listening in the lower capability mode and receives the ICF addressed to it on the narrow BW, e.g., 20 MHz, is to finish its CCA over the operating BW during the padding delay of the ICF frame. After the reception of the ICF frame, the non-AP STA should finish the CCA over the operating BW and can respond to an initial control response frame (ICR) on the operating BW after a SIFS following the reception of the ICF.

(7) After the successful exchange of ICF and ICR frames, a non-AP STA affiliated with the non-AP MLD that was listening on the operating BW of the corresponding link shall be able to transmit or receive frames on the link on which the ICF was received and shall not transmit or receive on the other EMLSR link(s) until the end of the frame exchange. The non-AP STA affiliated with the non-AP MLD shall be capable of receiving a PPDU that is sent using more than one Spatial Stream (SS) on the link on which the ICF has received a SIFS after the end of its responding frame transmission solicited by the ICF. During the frame exchanges, the other AP(s) affiliated with the AP MLD shall not transmit frames to the other non-AP STA(s) affiliated with the non-AP MLD on the other EMLSR link(s). (i) It should be noted that EMLMR enables the non-AP MLD to transmit and receive with a specific number of spatial streams NSS.

(8) The non-AP MLD shall be switched back to the listening operation with lower capability on the EMLSR link(s) after the most recently indicated EMLSR transition delay time, or if any of the following conditions are met before the most recently indicated EMLMR transition delay time.

(8)(a) After the non-AP STA affiliated with the non-AP MLD sends the ICR in response to the received ICF, and the non-AP STA hasn't received any response during a specific timeout interval, such as a SIFSTime+a SlotTime+a RxPHYStartDelay.

(8)(b) After the non-AP STA affiliated with the non-AP MLD sends the ICR in response to the received ICF, and the non-AP STA has received the response from the AP affiliated with the AP MLD, where the received response does not meet any of the following conditions: (i) an individually addressed frame directed to the non-AP STA; (ii) a Trigger frame that has one of the User Info fields addressed to the non-AP STA; (iii) a CTS-to-self frame addressed to the AP affiliated with the AP MLD; (iv) a Multi-STA BlockAck frame that has one of the Per AID TID Info fields addressed to the non-AP STA affiliated with the non-AP MLD; and (v) a Null Data Packet (NDP) Announcement frame that has one of the STA Info field addressed to the non-AP STA affiliated with the non-AP MLD.

(8)(c) The EMLSR transition delay time starts after the end of the Transmit Opportunity (TXOP), which was initiated by the non-AP STA. (i) It should be noted that the EMLSR/EMLMR transition delay time is the minimum delay required by a non-AP MLD to switch from exchanging frames on one of the EMLSR/EMLMR links to the listening operation on the EMLSR/EMLMR links when operating in EMLSR/EMLMR mode.

(9) The non-AP MLD operating on the lower capability mode can send a frame in any of the available EMLSR link(s) to the associated AP MLD to solicit the AP MLD to send an ICF to it in any of the available EMLSR link(s).

(10) The non-AP STA affiliated with the same non-AP MLD that has another affiliated non-AP STA has exchanged the ICF and ICR frames on one of the EMLSR links with the associated AP MLD and has received at least the Physical (PHY) header of the PPDU from the associated AP or has the buffered PPDU to send to the associated AP. Then, the non-AP STA, which is not the one exchanging the ICF and ICR frames with the associated AP MLD, can enter dozing mode on other EMLSR link(s). The duration of the doze mode can be set to the end of the TXOP as identified by the Network Allocation Vector (NAV) value on the EMLSR link that is detected or set for the frame exchanges initiated by the ICF frame. In this case, the non-AP STA can automatically switch from doze mode to active mode after the duration of the doze mode expires.

### 7.2. EMLMR-Based PS on Non-AP STA MLD Side

(1) The EML Operating Mode Notification frame, which is used to enable or disable the EMLMR mode over the EMLMR Link(s) as defined in Draft P802.11be_D6.0 is described herein updated to capture the needs for the STA(s) affiliated with the non-AP MLD operating on the enabled EMLMR link(s) to listen with lower capability mode.

(1)(a) The lower capability mode refers, by way of example and not limitation, as having the capabilities of 20 MHz BW, one SS, limited data rates, PPDU format. (i) The operation of the lower capability mode includes CCA and receiving the initial Control frame (ICF) of the frame exchanges that are initiated by the associated AP MLD. (ii) The operation of the lower capability mode includes CCA and transmitting, for example short control frame by the non-AP MLD.

(1)(b) The higher capability mode refers, by way of example and not limitation, operating BW, NSS and MCSs, with at least one value of these parameters specifying a higher capability than that of the lower power capability mode. (i) The operation of the higher capability mode includes CCA and transmitting the (un-solicited) initial Control Response (ICR) frame, DATA frame and Ack frame that are transmitted to or exchanged with the AP MLD.

(2) After the non-AP MLD starts operating in the EMLMR mode on the EMLMR link(s), the non-AP STA(s) operating on the enabled EMLMR link(s) should operate with the lower capability mode at the same time of the start time the EMLSR mode is enabled on the corresponding EMLMR link(s).

(3) The lower capability mode of the non-AP STA(s) operating on the enabled EMLMR link(s) is preferably disabled at the same time as the EMLMR mode is disabled over the corresponding EMLMR link(s).

(4) An AP affiliated with the AP MLD that initiates frame exchanges that are neither group addressed Data nor group addressed Management frames with the non-AP MLD on one of the EMLMR links, shall begin the frame exchanges by transmitting the ICF to the non-AP MLD with the limitations specified below:

(4)(a) The ICF frame of the frame exchanges shall be sent in the non-HT PPDU or non-HT duplicated PPDU format using a rate of X Mb/s, where X may be for example 6, 12, or 24, on for example the whole operating BW.

(4)(b) A padding should be included in the ICF frame to ensure that the non-AP STA affiliated with a non-AP MLD that is listening with the lower capability mode and receives the ICF over the narrow BW and has sufficient time to finish the CCA over the operating BW before sending a response to the ICR frame to the AP MLD. (i) A new intermediate FCS (pre-FCS) field should be carried in the ICF frames and located before the padding. In this case, the non-AP STA that is listening with the lower capability mode and receives the ICF over the narrow BW does not need to wait until it has finished decoding the FCS at the end of the ICF frame to start the transition. Instead, after decoding the intermediate FCS field of the ICF frame and identifying the successful reception of the ICF frame, the recipient non-AP STA can start transitioning from the lower capability mode to the higher capability mode.

(4)(c) The initial frame exchange can be any frame exchange as long as the soliciting frame satisfies the padding requirement

(5) A non-AP STA affiliated with a non-AP MLD that is listening with the lower capability mode on the narrow BW, e.g., 20 MHz, may initiate CCA over the wider operating BW without receiving any ICF frame from its associated AP MLD, and can transmit an un-solicited ICR frame to the affiliated AP on the wider operating BW after identifying CCA idle. The un-solicited ICR frame may or may not request an immediate response frame from the recipients.

(6) A non-AP STA affiliated with a non-AP MLD that is listening with the lower capability mode and receives the ICF addressed to it on the narrow BW, e.g., 20 MHz, shall finish CCA over the operating BW during the padding delay of the ICF frame. After the reception of the ICF frame, the non-AP STA should finish the CCA over the operating BW and can respond, within a SIFS, with an initial control response frame (ICR) on the operating BW.

(7) After the successful exchange of ICF and ICR frames, a non-AP STA affiliated with the non-AP MLD that was listening on the operating BW of the corresponding link shall be able to transmit or receive frames with the number of spatial streams up to the value as indicated in the EMLMR supported MCS and NSS Set on the link on which the ICF was received and shall not transmit or receive on the other EMLMR link(s) until the end of the frame exchange. During the frame exchanges, the other AP(s) affiliated with the AP MLD shall not transmit frames to the other non-AP STA(s) affiliated with the non-AP MLD on the other EMLMR link(s).

(8) After the end of the frame exchange sequence, each non-AP STA affiliated with the non-AP MLD in the EMLMR mode should switch to its per-link spatial stream capabilities and can switch back to the lower capability mode on the enabled EMLMR link(s).

(9) The non-AP MLD shall be switched back to the listening operation with lower capability on the EMLMR link(s) after the most recently indicated EMLMR transition delay time, or if any of the following conditions are met before the most recently indicated EMLMR transition delay time.

(9)(a) After the non-AP STA affiliated with the non-AP MLD sends the ICR as the response of the received ICF and the non-AP STA does not receive any response during certain timeout interval, for instance a SIFSTime+a SlotTime+a RxPHYStartDelay.

(9)(b) After the non-AP STA affiliated with the non-AP MLD sends the ICR as a response to the received ICF and the non-AP STA receives the response from the AP affiliated with the AP MLD, where the received response does not meet any of the following conditions: (i) an individually addressed frame having a destination of the non-AP STA; (ii) a Trigger frame that has one of the User Info fields addressed to the non-AP STA; (iii) a CTS-to-self frame addressed to the AP affiliated with the AP MLD; (iv) a Multi-STA BlockAck frame that has one of the Per AID TID Info fields addressed to the non-AP STA affiliated with the non-AP MLD; or (v) an NDP Announcement frame that has one of the STA Info field addressed to the non-AP STA affiliated with the non-AP MLD.

(10) The non-AP MLD operating on the lower capability mode can send a frame in any of the available EMLMR link(s) to the associated AP MLD to solicit the AP MLD to send an ICF to it in any of the available EMLMR link(s).

(11) The non-AP STA, affiliated with the same non-AP MLD that has another affiliated non-AP STA has exchanged the ICF and ICR frames on one of the EMLMR links with the associated AP MLD and has received at least the PHY header of the PPDU from the associated AP or has the buffered PPDU to send to the associated AP; then the non-AP STA, which is not the one exchanged between the ICF and ICR frames with the associated AP MLD can enter the doze mode on other EMLMR link(s). The duration of the doze mode can be set to the end of the TXOP as identified by the NAV value on the EMLMR link that is detected or set for the frame exchanges initiated by the ICF frame. The non-AP STA can automatically switch from doze mode to active mode after the duration of the doze mode expires in this case.

### 7.3. EMLSR-Based PS on AP-MLD Side

FIG. 5 illustrates the framework of an UHR AP MLD 210 that has AP1 212, AP2 214 and AP3 216 affiliated with an UHR AP MLD, which supports EMLSR operation mode to be enabled on all or a portion of the link set including Link1, Link2 and Link3. The EMLSR Radio 218 supports up to two Spatial Streams (SSs) 220 on each link. The EMLSR radio only allows one of the EMLSR links 224 (solid line) to operate with high capability mode at a given time during which the EMLSR mode is enabled on multiple EMLSR links.

(1) The EMLSR operation is preferably enabled on the AP MLD side, wherein the AP may broadcast or groupcast the EML Operation Mode Notification (OMN) frame to its associated non-AP STAs and may require the EML Operation Mode Notification frames from the associated non-AP STAs that can be carried in an Uplink (UL) Multi-User (MU) transmission, or it may elect not to require any response from the associated non-AP STAs. In view of the above, the EML Operating Mode Notification frame, which provides for enabling or disabling EMLSR mode over the EMLSR Link(s) as defined in Draft P802.11be_D6.0, should be further configured for the AP MLD side and should be designed to capture the needs for the AP(s) affiliated with the AP MLD operating on the enabled EMLSR link(s) to listen with the lower capability mode.

(1)(a) The lower capability mode refers, for example and not limitation to a 20 MHz BW, one SS, limited data rates, PPDU format. (i) The operation of the lower capability mode includes CCA and receiving the initial Control (ICF) frame of the frame exchanges that are initiated by the non-AP MLD, which is associated with the AP MLD. (ii) The operation of the lower capability mode includes CCA and transmitting frames, for example a short control frame by the AP MLD.

(1)(b) The higher capability mode refers for example and not limitation to an operating BW, NSS and MCSs, with at least one value of these parameters specifying a higher capability than that of the lower power capability mode. (i) The operation of the higher capability mode includes CCA and transmitting the (un-solicited) initial Control Response (ICR) frame, DATA frame and Ack frame that are transmitted to, or exchanged with, the AP MLD.

(2) After the AP MLD starts operating in the EMLSR mode on the EMLSR link(s), the AP(s) operating on the enabled EMLSR link(s) should operate in the lower capability mode simultaneous with enabling the EMLSR mode on the corresponding EMLSR link(s).

(3) The AP MLD may select to keep one or more link(s) to operate as EML disabled link(s) while other links are operating as EML(SR) enabled links. The EML disabled link(s) should maintain Active mode.

(4) The lower capability mode of the AP(s) operating on the enabled EMLSR link(s) should be disabled at the same time that the EMLSR mode is disabled over the corresponding EMLSR link(s).

(5) The EMLSR link(s) with the EMLSR mode that are enabled for the AP MLD need not be the same set of EMLSR link(s) having the EMLSR mode enabled for the non-AP MLD that is associated with the AP MLD.

(6) An AP affiliated with an AP MLD that is listening in the lower capability mode on the narrow BW, e.g., 20 MHz, can initiate CCA over the wider operating BW without receiving any ICF frame from its associated non-AP MLD, and can broadcast an un-solicited ICR frame on the wider operating BW after identifying CCA idle. The un-solicited ICR frame is not required to request an immediate response frame from the recipients.

(7) A non-AP STA affiliated with a non-AP MLD that initiates frame exchanges with the AP MLD on one of the EMLSR enabled links shall begin the frame exchanges by transmitting the ICF to the AP MLD with the limitations specified below.

(7)(a) The ICF frame of the frame exchanges shall be sent in the non-HT PPDU or non-HT duplicated PPDU format using a rate of X Mb/s, where X may for example be 6, 12, or 24, such as for example referring to the entire operating BW.

(7)(b) Padding should be included in the ICF frame to ensure that the AP affiliated with the AP MLD that is listening in the lower capability mode and receives the ICF over the narrow BW has sufficient time to finish CCA over the operating BW before sending a response to the non-AP MLD in response to receiving the ICR frame. (i) New intermediate FCS fields should be carried in the ICF frames, with the FCS fields located before the padding. In this case, the AP that is listening in the lower capability mode and receives the ICF over the narrow BW does not need to wait until decoding the FCS at the end of the ICF frame to start the transition. Instead, after decoding the intermediate FCS field of the ICF frame and identifying the successful reception of the ICF frame, the recipient AP can start a transition from lower capability mode to higher capability mode.

(7)(c) The ICF frame can be a control frame that can be initiated from the non-AP STA side and satisfies the padding requirement.

(7)(d) The ICR frame can be a response frame of the ICF frame that could be sent by AP.

(8) An AP affiliated with an AP MLD that is listening in the lower capability mode and receives the ICF addressed to it on the narrow BW, for example 20 MHz, shall process the CCA over the operating BW during the padding delay of the ICF frame. After the reception of the ICF frame, the AP should finish the CCA over the operating BW and can respond with an initial control response frame (ICR) on the operating BW a SIFS after the reception of the ICF.

(9) After the successful exchange of ICF and ICR frames, or broadcasts of an un-solicited ICR frame, an AP affiliated with the AP MLD that was listening on the operating BW of the corresponding link shall be able to transmit or receive frames on the link on which the ICF was received or the un-solicited ICR frame was broadcast and shall not transmit or receive on the other EMLSR link(s) until the end of the frame exchange. The AP affiliated with the AP MLD shall be capable of receiving or transmitting (MU)PPDU(s) that is sent using more than one spatial stream on the link on which the ICF has received a SIFS after the end of its responding frame transmission solicited by the ICF or a SIFS after the end of the un-solicited ICR it transmitted. During these frame exchanges, the other non-AP STA(s) may or may not be affiliated with the same non-AP MLD, and shall not transmit frames to the other AP(s) affiliated with the same AP MLD on the other EMLSR link(s), over which no ICF was received and no un-solicited ICR frame was broadcast.

(10) The AP MLD shall be switched back to the listening operation in the lower capability mode on the EMLSR link(s) after the most recently indicated EMLSR transition delay time, or if any of the following conditions is met before the most recently indicated EMLMR transition delay time.

(10)(a) After the AP affiliated with the AP MLD sends the ICR as a response to a received ICF, or sends an un-solicited ICR and the AP does not receive any response during a certain timeout interval, e.g., aSIFSTime+aSlotTime+aRxPHYStartDelay and the AP does not have any packet to transmit.

(10)(b) After the AP affiliated with the AP MLD sends the ICR as the response of the received ICF or sends the un-solicited ICR and the AP received the response from the non-AP STA affiliated with any non-AP MLD, where the received response does not meet any of the following conditions: (i) an individually addressed frame addressed to the AP; (ii) a CTS-to-self frame addressed to the non-AP STA affiliated with a non-AP MLD; (iii) a Multi-STA BlockAck (BA) frame that has the Per AID TID Info fields addressed to the AP affiliated with the AP MLD; or (iv) an NDP Announcement frame that has the STA Info field addressed to the AP affiliated with the AP MLD.

(10)(c) The EMLSR transition delay time shall start after the end of the TXOP, which was initiated by the AP.

(11) The AP MLD operating on the lower capability mode could send a frame in any of the available EMLSR link(s) to the associated non-AP MLD to solicit any non-AP MLD to send an ICF to it in any of the available EMLSR link(s).

(12) The AP MLD operating in the lower capability mode can initiate the transmission of an EML Operating Mode Notification frame with lower capability mode or with high capability mode. If the latter is applied, the AP can transition from lower capability mode to high capability mode with or without the reception of an ICF from its associated non-AP STA.

(13) The AP affiliated with the same AP MLD, that has another affiliated AP, exchanges the ICF and ICR frames or sends the un-solicited ICR frame on one of the EMLSR links with an associated non-AP MLD and receives at least the PHY header of the PPDU from the associated non-AP or has the buffered PPDU to send to the associated non-AP STA(s). Then, the AP, which is not the one exchanging the ICF and ICR frames or sending the un-solicited ICR to the associated non-AP MLD can switch to doze mode on other enabled EMLSR link(s). The duration of the doze mode can be entered at the end of the TXOP as identified by the NAV value on the EMLSR link that is detected or set for the frame exchanges initiated by the ICF frame or the un-solicited ICR frame. The AP can automatically switch from doze mode to active mode after the duration of the doze mode expires in this case.

### 7.4. EMLMR-Based PS on AP MLD Side

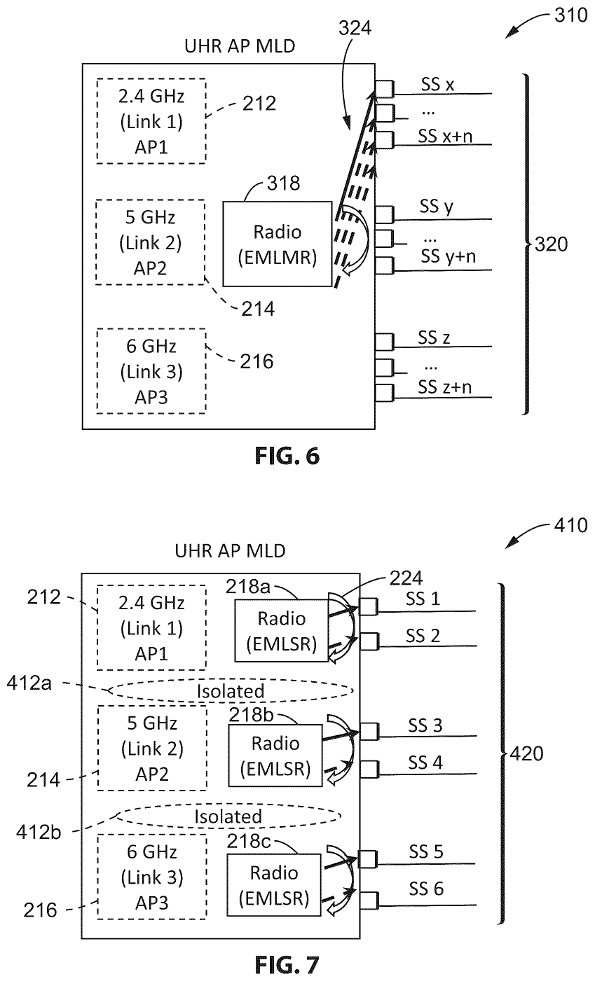

FIG. 6 illustrates the framework 310 of an UHR AP MLD that has AP1 212, AP2 214 and AP3 216 affiliated with an UHR AP MLD, which supports EMLSR operation mode to be enabled on all or a portion of the link set including Link1, Link2 and Link3. The EMLMR Radio 318 supports up to ‘n’ Spatial Streams (SSs) 320 on one link. The EMLMR radio can only allow for one of the EMLMR links to operate with high capability 324 (solid line) mode at any given time during which the EMLMR mode is enabled on multiple EMLMR links.

(1) The EMLMR operation should be enabled on the AP MLD side, wherein the AP may broadcast or groupcast the EML Operation Mode Notification frame to its associated non-AP STAs and may require an MU Block Ack (BA) and/or EML Operation Mode Notification frames that can be carried in a UL MU transmission format as the response frame from the associated non-AP STAs, or alternatively no response may be required from the associated non-AP STAs. The EML Operating Mode Notification frame, which is used to enable or disable the EMLMR mode over the EMLMR Link(s) as defined in Draft P802.11be_D6.0 should be further configured as described herein for the AP MLD side and updated to capture the needs for the AP(s) affiliated with the AP MLD operating on the enabled EMLMR link(s) to listen with lower capability mode.

(1)(a) The lower capability mode refers to, by way of example and not limitation, to having a 20 MHz BW, one SS, limited data rates, PPDU format. (i) The operation of the lower capability mode includes CCA and receiving the initial Control (ICF) frame of the frame exchanges that are initiated by the non-AP MLD, which is associated with the AP MLD. (ii) The operation of the lower capability mode includes CCA and transmitting, for example short control frame by the AP MLD.

(1)(b) The higher capability mode refers to, by way of example and not limitation, to having a desired operating BW, NSS and MCSs, with at least one value of these parameters that indicates a higher capability than that in the lower power capability mode. (i) The operation of the higher capability mode includes CCA and transmitting the (un-solicited) initial Control Response (ICR) frame, DATA frame and Ack frame that are transmitted to or exchanged with the non-AP MLD.

(2) After the AP MLD starts operating in the EMLMR mode on the EMLMR link(s), the AP(s) operating on the enabled EMLMR link(s) should operate with the lower capability mode at the same time as the start time of the EMLSR mode is enabled on the corresponding EMLMR link(s).

(3) The AP MLD may choose to keep one or more link(s) to operate as EML disabled link(s) while other links are operating as EML(MR) enabled links. The EML disabled link(s) should maintain Active mode.

(4) The lower capability mode of the AP(s) operating on the enabled EMLMR link(s) should be disabled at the same time as the EMLMR mode are disabled over the corresponding EMLMR link(s).

(5) The EMLMR link(s) with the EMLMR mode enabled for AP MLD need not be the same set of EMLMR link(s) with the EMLMR mode enabled for a non-AP MLD that is associated with the AP MLD.

(6) An AP affiliated with an AP MLD that is listening with the lower capability mode on a narrow BW, such as 20 MHz, may initiate CCA over the wider operating BW, without receiving any ICF frame from any of its associated non-AP MLD, and can broadcast or groupcast an un-solicited ICR frame on the wider operating BW, after identifying that the CCA is idle. The un-solicited ICR frame may request an immediate response frame from the recipients.

(7) A non-AP affiliated with a non-AP STA MLD that initiates frame exchanges with the AP MLD on one of the EMLMR links shall begin the frame exchanges by transmitting the ICF to the AP MLD with the limitations specified below.

(7)(a) The ICF frame of the frame exchanges shall be sent in the non-HT PPDU or non-HT duplicated PPDU format using a rate of X Mb/s, where X may be for example 6, 12, or 24, and for example indicate the entirety of the operating BW.

(7)(b) A padding should be included in the ICF frame to ensure that the AP affiliated with an AP MLD that is listening with the lower capability mode and receives the ICF over the narrow BW has sufficient time to complete its CCA over the operating BW before sending a response to the non-AP MLD in response to the received ICR frame. (i) A new intermediate FCS (pre-FCS) field should be carried in the ICF frames, with the FCS field located before the padding. In this case, the AP that is listening in the lower capability mode and receives the ICF over the narrow BW is not required to wait until the FCS at the end of the ICF frame has been decoded before it commences the transition. Instead, after decoding the intermediate FCS field of the ICF frame and identifying the successful reception of the ICF frame, the recipient AP can start the transition from the lower capability mode to the higher capability mode.

(7)(c) The initial frame exchange could be any frame exchange as long as the soliciting frame satisfies the padding requirements.

(8) An AP affiliated with an AP MLD that is listening in the lower capability mode and receives the ICF addressed to it on the narrow BW, such as 20 MHz, shall process the CCA over the wider operating BW during the padding delay of the ICF frame. After the reception of the ICF frame, the AP should finish the CCA over the wider operating BW and can respond, within a SIFS, with an Initial Control Response frame (ICR) on the wider operating BW.

(9) After successfully exchanging ICF and ICR frames, or broadcasting an un-solicited ICR, an AP affiliated with the AP MLD that was listening on the wider operating BW of the corresponding link is able to transmit or receive frames with the number of Spatial Streams (SSs) up to and including the value as indicated in the EMLMR supported MCS and NSS Set on the link on which the ICF was received or the un-solicited ICR frame was broadcast and shall not transmit or receive on the other EMLMR link(s) until the end of the frame exchange. The AP affiliated with the AP MLD shall be capable of receiving or transmitting (MU) PPDU(s) that is sent using the EMLMR supported MCS and NSS Set on the link on which the ICF has received a SIFS after the end of its responding frame transmission solicited by the ICF or a SIFS after the end of the un-solicited ICR it transmitted. During the frame exchanges, the other non-AP STA(s), which may or may not be affiliated with the same non-AP MLD, shall not transmit frames to the other AP(s) affiliated with the same AP MLD on the other EMLMR link(s), on which no ICF was received nor to which the un-solicited ICR frame was broadcast.

(10) After the end of the frame exchange sequence, each AP affiliated with the AP MLD in the EMLMR mode should switch to its per-link spatial stream capabilities and can switch back to the lower capability mode on the enabled EMLMR link(s).

(11) The AP MLD shall be switched back to a listening operation in the lower capability mode on the EMLMR link(s) after the most recently indicated EMLMR transition delay time, or if any of the following conditions are met before the most recently indicated EMLMR transition delay time.

(11)(a) After the AP affiliated with the AP MLD sends the ICR as the response to the received ICF, or sends the un-solicited ICR and the AP does not receive any response during certain timeout interval, e.g., aSIFSTime+aSlotTime+aRxPHYStartDelay and AP doesn't have any packet to transmit.

(11)(b) After the AP affiliated with the AP MLD sends the ICR in response to the received ICF, or sends the un-solicited ICR and the AP STA receives the response from the non-AP STA affiliated with the non-AP MLD, where the received response does not meet any of the following conditions: (i) an individually addressed frame directed to the AP STA; (ii) a CTS-to-self frame addressed to the non-AP affiliated with the non-AP MLD; (iii) a Multi-STA BlockAck (BA) frame that has the Per AID TID Info fields addressed to the AP affiliated with the AP MLD; or (iv) an NDP frame that has the STA Info field addressed to the AP affiliated with the AP MLD.

(12) The AP MLD operating on the lower capability mode can send a frame in any of the available EMLMR link(s) to any associated non-AP MLD to solicit the non-AP MLD to send an ICF to it in any of the available EMLMR link(s).

(13) The AP MLD operating on the lower capability mode can initiate the transmission of EML Operating Mode Notification frame with a lower capability mode or with a higher capability mode. If the latter is applied, the AP can transition from lower capability mode to higher capability mode with or without the reception of an ICF from its associated non-AP STA.

(14) The AP affiliated with the same AP MLD that has another affiliated AP STA exchanges the ICF and ICR frames, or sends the un-solicited ICR frame on one of the EMLMR links with the associated non-AP MLD and receives at least the PHY header of the PPDU from the associated non-AP or has the buffered PPDU to send to the associated non-AP STA(s). Then, the AP, which is not the one exchanging ICF and ICR frames or sending the un-solicited ICR to the associated non-AP MLD, can enter the doze mode on other EMLMR link(s). The duration of the doze mode can be set to the end of the TXOP as identified by the NAV value on the EMLMR link that is detected or set for the frame exchanges initiated by the ICF frame or the un-solicited ICR frame. In this case, the AP can automatically switch from doze mode to active mode after the duration of the doze mode expires.

7.5. EMLSR-Based PS on AP MLD Side with Isolated Radio

FIG. 7 illustrates the framework 410 of an UHR AP MLD that has AP1 212, AP2 214 and AP3 216 affiliated with an UHR AP MLD, which supports EMLSR operation mode to be enabled on Link1, Link2 and Link3. In addition, there are separate radios 218a, 218b, 218c operating on each link, which in some applications may be isolated 412a, 412b radios, having separate outputs 420. This isolation for example means that these radios have distinct or similar basebands which have a sufficient level of isolation between one another, in terms of power splatter and out-of-band emissions, so that the inter-band or inter-link interference across bands can be neglected. The EMLSR radio supports up to two Spatial Streams (SSs) 224 on each link. The EMLSR radio can serve one or a portion of all of the EMLSR links with higher capability mode at one time during which the EMLSR modes are enabled on the EMLSR links.

It should be noted that for this scenario all the embodiments introduced in Section 7.3 may apply. However, elements (9) and (13) provide additional aspects which also apply, as indicated by being surrounded with brackets, in the text below.

(9) After successfully exchanging of ICF and ICR frames, or the broadcast of an un-solicited ICR frame, an AP affiliated with the AP MLD that was listening on the operating BW of the corresponding link is able to transmit or receive frames on the link on which the ICF was received or the un-solicited ICR frame was broadcasted.

[During the frame exchange initiated by the successful exchange of ICF and ICR frames or by the broadcasted un-solicited ICR frame on one link (e.g., Link1), the other AP(s) affiliated with the same AP MLD on the other EMLSR enabled link(s) (e.g., Link2 and Link3) can perform the same procedure to transition from the lower capability mode to the higher capability mode to exchange frames with associated non-AP STA(s) that may be affiliated with the same non-AP MLD as the one with which the non-AP STA is affiliated and is exchanging frames with the AP operating with a higher capability mode on Link1.]

The AP affiliated with the AP MLD shall be capable of receiving or transmitting (MU) PPDU(s) that are sent using more than one Spatial Stream (SS) on the link on which the ICF has received a SIFS after the end of it responding to a frame transmission solicited by the ICF or a SIFS after the end of the un-solicited ICR it transmitted. During the frame exchanges, the other non-AP STA(s) may be affiliated with the same non-AP MLD and shall not transmit frames, [that need the recipient to operate in higher capability mode,] to the other AP(s) that are affiliated with the same AP MLD on the other EMLSR link(s), on which no ICF was received nor to which the un-solicited ICR frame was broadcast.

(13) The AP affiliated with the same AP MLD that has another affiliated AP STA exchanges the ICF and ICR frames or sends the un-solicited ICR frame on one of the EMLSR links with the associated non-AP MLD and receives at least the PHY header of the PPDU from the associated non-AP or has the buffered PPDU to send to the associated non-AP STA(s). Then the AP, which is not the AP which is exchanging the ICF and ICR frames or sending the un-solicited ICR to the associated non-AP MLD, [should not enter the doze mode on other enabled EMLSR link(s), in case there will be an incoming exchange of the ICF and ICR frames or the broadcast of the un-solicited ICR frame].

7.6. UHR AP MLD EMLMR with Isolation

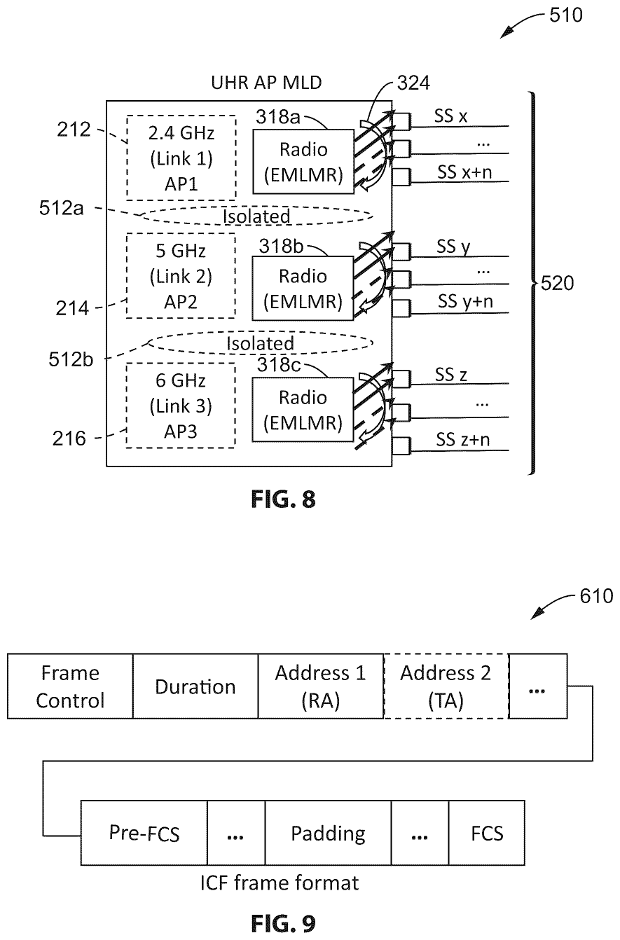

FIG. 8 illustrates 510 the framework of an UHR AP MLD that has AP1 212, AP2 214 and AP3 216 affiliated with an UHR AP MLD, which supports EMLMR operation mode to be enabled on Link1, Link2 and Link3. In addition, there are separate radios 318a, 318b, and 318c, operating on each link, which may or may not be isolated (512a, 512b) radios having distinct or the same basebands and which have a sufficient level of isolation between each other in terms of power splatter and out-of-band emission so that the inter-band or inter-link interference across bands can be neglected. The EMLMR radio supports up to ‘n’ Spatial Streams (SSs) on one link. The EMLMR radio can simultaneously serve one or a portion of all of the EMLMR links with a high capability mode during which the EMLMR mode are enabled on the EMLMR links.

It should be noted that for this scenario all the embodiments introduced in Section 7.4 may apply. However, for elements (1), (9) and (14) there are additions, indicated by being surrounded below with brackets, to that which was introduced in section 7.4, as shown below.

(1) The EMLMR operation should be enabled on the AP MLD side, wherein the AP may broadcast or groupcast the EML Operation Mode Notification frame to its associated non-AP STAs and may require an MU block Ack and/or EML Operation Mode Notification frames that can be carried in UL MU transmission format as the response frame from the associated non-AP STAs or may not require any response from the associated non-AP STAs.

[The broadcasted EML Operation Mode Notification frame should indicate MCS, NSS for Transmit and Receive with high capability mode on each EMLMR enabled link(s). The MCS, NSS for high capability mode can have multiple parameter sets designed to indicate different requirements of the high capability mode when the transition from lower capability mode to high capability mode is applied to different single links or multiple links.]

The EML Operating Mode Notification frame, which is used to enable or disable EMLMR mode over the EMLMR Link(s) as defined in Draft P802.11be_D6.0 should be further configured as described herein for the AP MLD side and should be updated to capture the needs for the AP(s) affiliated with the AP MLD operating on the enabled EMLMR link(s) to listen with lower capability mode.

(9) After the successful exchange of ICF and ICR frames or broadcast of an un-solicited ICR, an AP affiliated with the AP MLD that was listening on the operating BW of the corresponding link shall be able to transmit or receive frames with a number of spatial streams up to the value as indicated in the EMLMR supported MCS and NSS Set on the link on which the ICF was received or the un-solicited ICR frame was broadcasted.

[During the frame exchange initiated by the successful exchange of ICF and ICR frames or by the broadcasted un-solicited ICR frame on one link (e.g., Link 1), the other AP(s) affiliated with the same AP MLD on the other EMLMR enabled link(s) (e.g., Link 2 and Link 3) can perform the same procedure to transition from the lower capability mode to the higher capability mode to exchange frames with the associated non-AP STA(s) that may be affiliated with the same non-AP MLD as the one with which the non-AP STA is affiliated and is exchanging frames with the AP operating with higher capability mode on Link 1.]

The AP affiliated with the AP MLD shall be capable of receiving or transmitting (MU) PPDU(s) that are sent using the EMLMR supported MCS and NSS Set on the link on which the ICF has received a SIFS after the end of its responding frame transmission solicited by the ICF or a SIFS after the end of the un-solicited ICR is transmitted. During the frame exchanges, the other non-AP STA(s) may not be affiliated with the same non-AP MLD and shall not transmit frames, [that need the recipient to operate in higher capability mode,] to the other AP(s) affiliated with the same AP MLD on the other EMLMR link(s), on which no ICF was received nor was an un-solicited ICR frame broadcast.

(14) The AP affiliated with the same AP MLD that has another affiliated AP STA, exchanges the ICF and ICR frames or sends the un-solicited ICR frame on one of the EMLMR links with the associated non-AP MLD and has received at least the PHY header of the PPDU from the associated non-AP or has the buffered PPDU to send to the associated non-AP STA(s). Then, the AP, which is not the one exchanging the ICF and ICR frames or sending the un-solicited ICR to the associated non-AP MLD, [should not enter into doze mode on other enabled EMLMR link(s), in case there will be an incoming exchange of ICF and ICR frames or broadcasts of the un-solicited ICR frame].

### 8. Frame Format

### 8.1. Initial Control Frame (ICF)

FIG. 9 illustrates a frame format 610 of an Initial Control Frame (ICF) for the present disclosure. The Frame Control, Duration and Address 1 (e.g., Receiver Address (RA)) fields are present in all control frame subtypes. The Address 2 (e.g., Transmitter Address (TA)) field is present in selected control frame subtypes. The FCS field contains a CRC, or other subfield utilized for detecting accidental changes/errors in the communication channel. The FCS field is included at the end of the ICF and the FCS value is calculated over all of the fields of the MAC header and the Frame Body field.

The pre-FCS field is preferably included in the ICF, and in at least one example is specifically located in the MAC header to allow the receiver of the ICF frame to commence all actions corresponding to this ICF frame after decoding the pre-FCS field, instead of the FCS field, and then it can ignore the trailing bits and utilize the trailing bits as padding. It should be appreciated that the pre-FCS field can only be recognized by UHR devices. The padding field provides sufficient time for the switch delay. The pre-FCS field and its corresponding padding field can be configured on a per user basis in a frame addressing multiple users, or per frame which addresses a single user.

### 9. Operational Examples

### 9.1. EMLSR-Based PS on Non-AP STA MLD Side

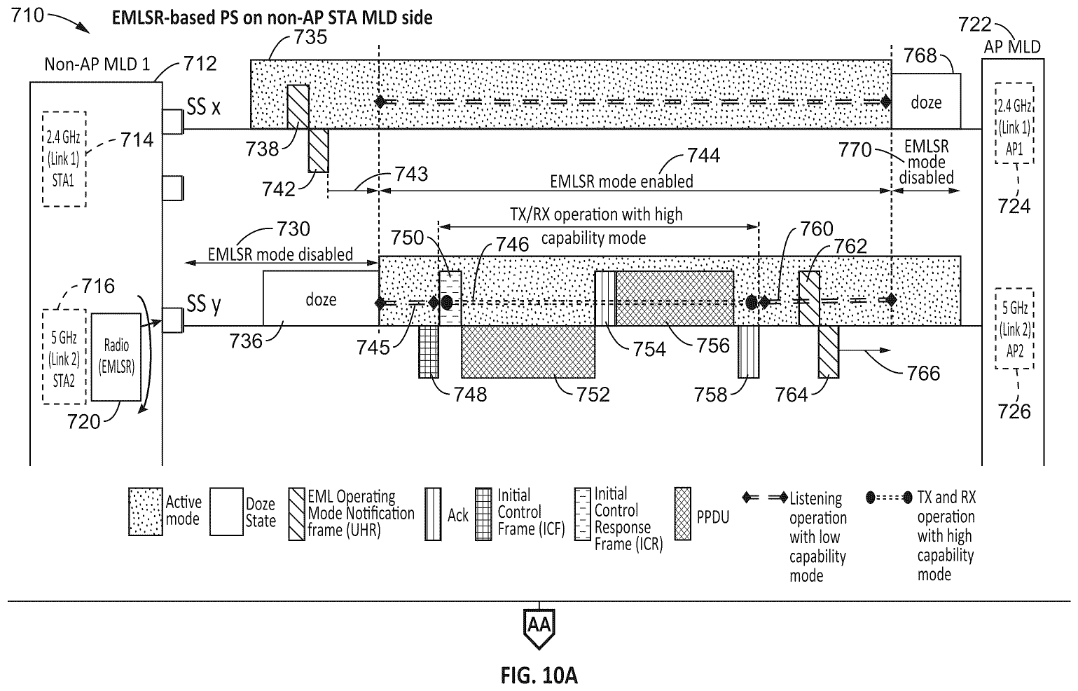

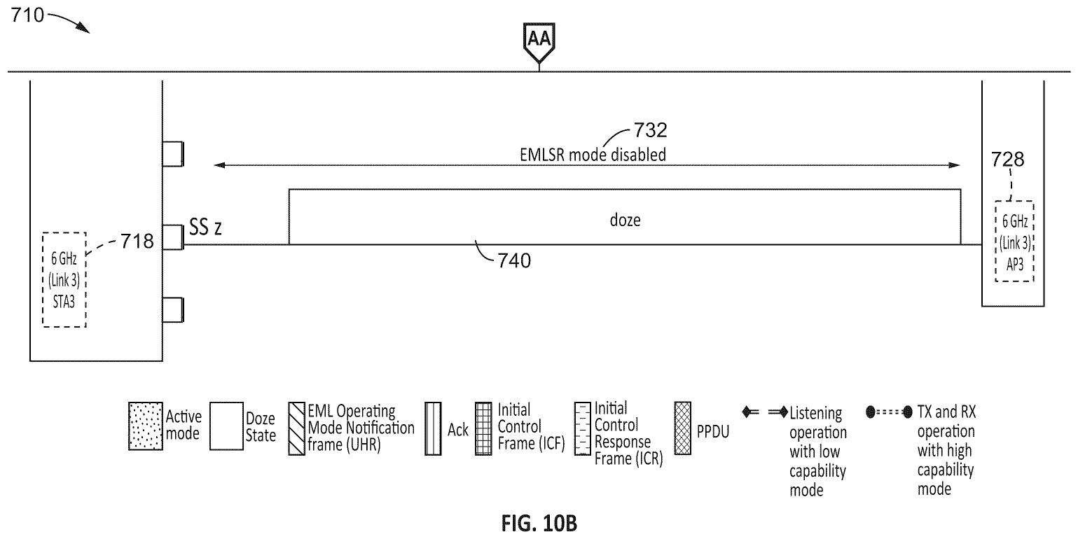

FIG. 10A and FIG. 10B illustrates an example 710 of an EMLSR-based PS on the non-AP STA MLD side. A non-AP MLD 712 is shown with STA1 (Link1) 714, STA2 (Link2) 716 and STA3 (Link3) 718, shown working through EMLSR 720, which is communicating to AP MLD 722 having AP1 (Link1) 724, AP2 (Link2) 726, and AP3 (Link3) 728.

The non-AP MLD supports operation in EMLSR mode on the EMLSR Links including Link1, Link2 and Link3. Following the procedure as defined in Draft P802.11be_D6.0, STA1 of non-AP MLD1 shall operate in the EMLSR mode on EMLSR Link1 at the end of the transition timeout interval.

STA1 is seen in active mode 735 sending an EML operating mode notification frame 738 to AP1 to enable EMLSR mode on Link1, to which AP1 responds 742, after which is a transmission timeout interval 743. During this time STA2 (Link2) and STA3 (Link3) are in Doze mode 736, 740 with EMLSR disabled 730, 732.

Then, after transmission timeout interval 743, STA2 affiliated with the non-AP MLD 1 operating on the corresponding EMLSR Link 2, which did not transmit the EML Operating Mode Notification frame, shall transition to active mode 744 without being required to transmit a frame with the Power Management subfield set to a value of 0, at the end of the transition timeout interval. STA1 is also shown entering into the listening mode n the lower capability mode following timeout 743.

STA3 affiliated with the non-AP MLD 1 operating on the corresponding EMLSR Link3, which did not transmit the EML Operating Mode Notification frame, shall continue operating in doze state 740, since the EMLSR mode is disabled on Link3 as indicated in the exchanged EML Operating Mode Notification frames on Link1.

After the EMLSR Mode is enabled on Link1 and Link2, STA1 and STA2 perform listening operations 745 in the lower capability mode, such as for example limited to a 20 MHz BW, one SS, limited data rates, PPDU format, and so forth.

During listening in the lower capability mode over Link 2, STA2 receives the ICF frame 748 from AP2 and responds with ICR frames 750 over Link2. Then, STA2 can exchange frames (e.g., PPDU) 752 with AP2 over Link2 with the higher capability mode 746 which refers to operating with at least one parameter setting indicative of higher capability than that found in the lower capability mode. AP2 sends an Ack 754, then AP2 is shown sending a PPDU 756, to which STA2 Acks 758. Of course the above exchanges are described by way of example and not limitation. During these frame exchanges, AP1 shall not transmit frames to STA1 on Link1.

STA2 at this point returns to listening 760 in the low capability mode, and it receives a frame 762 indicating to disable the EMLSR mode on Link1 and Link2, to which it responds 764 in acknowledgement, upon which a transition timeout interval 766 commences.

After the successful exchange of EML Operating Mode Notification frames between STA2 and AP2 to disable the EMLSR mode over Link1 and Link2, STA1 and STA2 disable the EMLSR mode 770 at the end of the transition timeout interval. Then, STA1 may transition to power save mode 768.

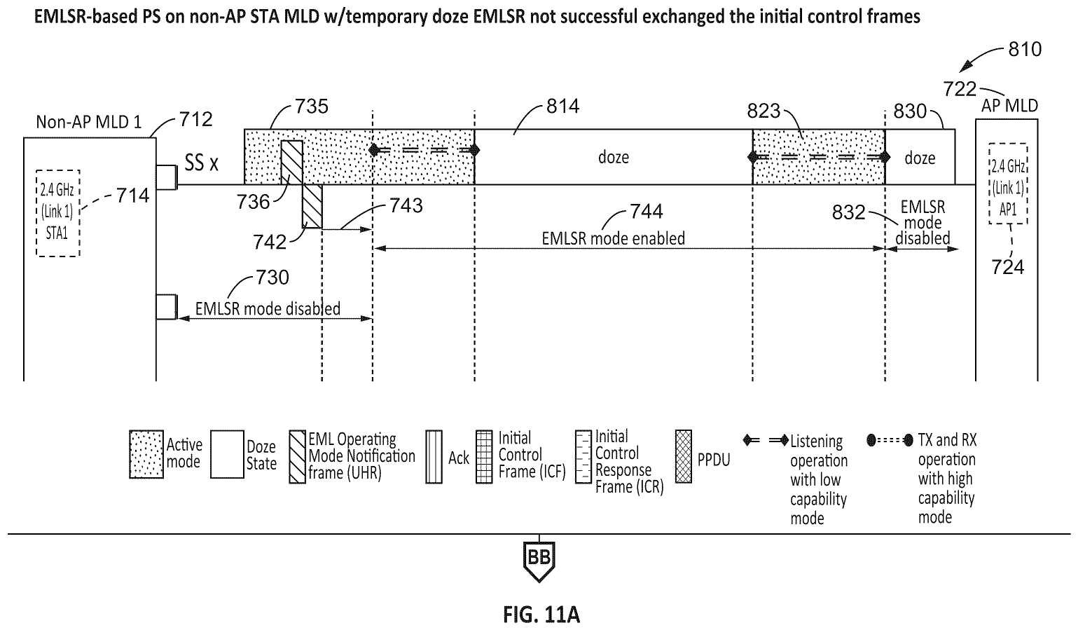

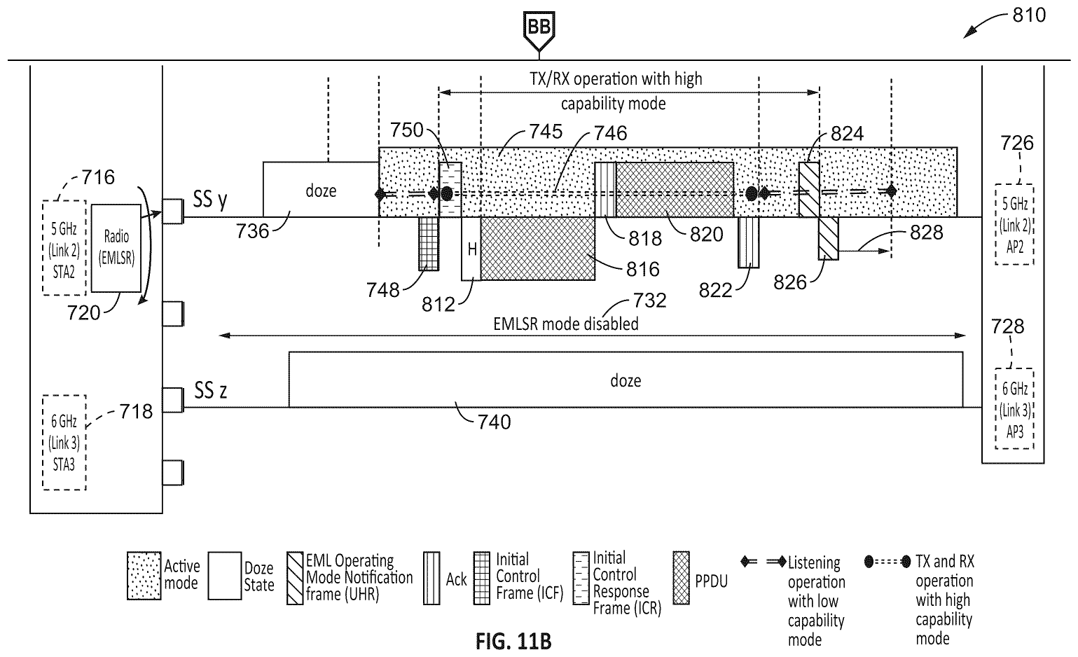

FIG. 11A and FIG. 11B illustrate an example 810 of an EMLSR-based PS on non-AP STA MLD side with temporary dozing EMLSR link(s).

A non-AP MLD 712 is shown with STA1 (Link1) 714, STA2 (Link2) 716 and STA3 (Link3) 718, shown working through EMLSR 720, which is communicating to AP MLD 722 having AP1 (Link1) 724, AP2 (Link2) 726, and AP3 (Link3) 728.

The non-AP MLD supports operation in the EMLSR mode on the EMLSR Links including Link1, Link2 and Link3. Following the procedure as defined in Draft P802.11be_D6.0, STA1 of non-AP MLD 1 shall operate in the EMLSR mode on EMLSR Link1 at the end of the transition timeout interval.

The beginning of this sequence is exactly as outlined for FIG. 10A and FIG. 10B. Then STA2 affiliated with the non-AP MLD 1 operating on the corresponding EMLSR Link 2, which did not transmit the EML Operating Mode Notification frame, shall transition to active mode and listening in the low capability mode 745 without being required to transmit a frame with the Power Management subfield set to a value of 0, at the end of the transition timeout interval.

Then after the ICF exchange 748, 750, then STA2 could exchange frames with AP2 over Link 2 with higher capability mode 746. Block 812, marked with an ‘H’, is the header of PPDU 816. During these frame exchanges and acknowledgements 812, 816, 818, 820, 822, AP1 shall not transmit frames to STA1 on Link1, while STA1 can switch to doze mode 814 on Link1 once STA2 has identified, after the exchange of the ICF and ICR frames on Link2, the (e.g., NAV) duration of the PPDU or the TXOP that is indicated in the frame header of the received frame or estimated based on the buffered PPDU. STA1 can then switch from doze mode 814 back to active mode 823 on Link1 after STA2 identified the PPDU or the TXOP finished on Link2.

After the successful exchange of EML Operating Mode Notification frames 824, 826 between STA2 and AP2 the EMLSR mode over Link1 and Link2 then after a transition timeout interval 828, then the EMLSR mode is disabled 832 and STA1 may then transition to power save mode 830.

### 9.2. EMLMR-Based PS on Non-AP STA MLD Side

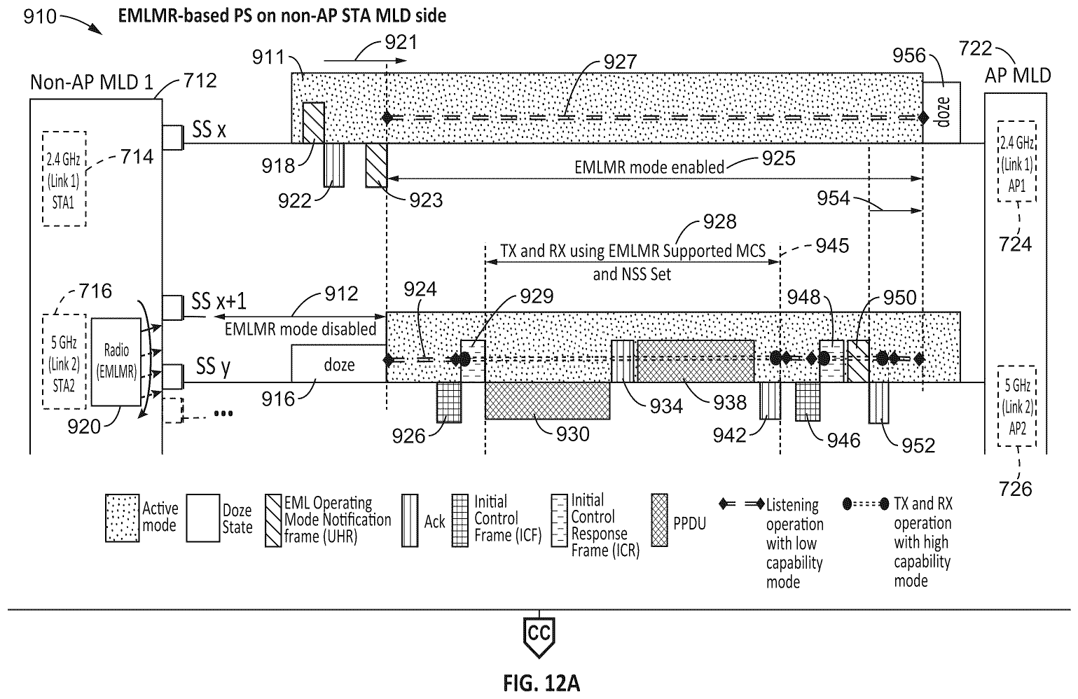

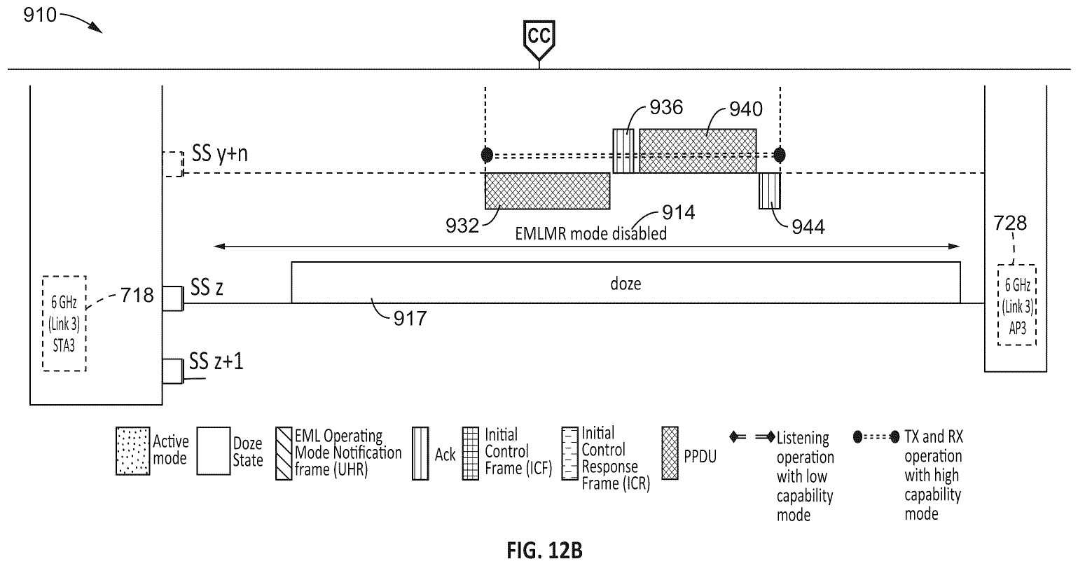

FIGS. 12A and 12B illustrate an example 910 of an EMLMR-based PS on non-AP STA MLD side.

A non-AP MLD 712 is shown with STA1 (Link1) 714, STA2 (Link2) 716 and STA3 (Link3) 718, shown working through EMLMR 920, which is communicating to AP MLD 722 having AP1 (Link1) 724, AP2 (Link2) 726, and AP3 (Link3) 728.

The non-AP MLD 1 supports operation in the EMLMR mode on the EMLMR Links including Link1, Link2 and Link3. Following the procedure as defined in Draft P802.11be_D6.0, STA1 of the non-AP MLD1, during its active mode 911, successfully transmits the EML Operating Mode Notification frame 918 to AP1 affiliated with AP MLD 1, and receives an Ack 922 from AP2, after which AP1 sends an EML Operating Mode Notification response 923 to STA1 to confirm the mode switch at the AP MLD to STA1, where it commences listening 927 in the low capability mode.

The non-AP MLD 1 transitions to the EMLMR mode on EMLMR Link1 and EMLMR Link2 immediately after receiving the EML Operating Mode Notification frame from the AP1, which takes place before transition timeout 921 expires.

The EMLMR mode is not enabled 914 on Link3 and STA3 remains in doze state 917 on Link3.

After the EMLMR Mode is enabled 925 on Link1 and Link2, STA1 and STA2 perform listening operations in the lower capability mode.

During listening mode 924 over Link 2, STA2 receives an ICF frame 926 from AP2 and responds with ICR frame 929 over link2 to AP2 and commences a switch to the higher capability mode. Immediately after STA2 sent the ICR frame, it processes the NSS switch 928 from the other EMLMR Link(s) to the EMLMR Link2, and can commence a number of spatial streams up to ‘n’ number of SSs as per this example. Then STA2 receives and transmits PPDUs (e.g., 930, 932, 938, 940), and transmits and receives Acks (e.g., 934, 936, 942, 944) with the number of spatial streams of ‘n’ on Link2.

After the end 945 of the frame exchange sequence, STA2 performs the NSS switch from EMLMR Link2 to other EMLMR link(s). STA1 and STA2 return to listening in the lower capability mode.

While listening in the lower capability mode over Link 2, STA2 receives an ICF frame 946 from AP2 and responds with ICR frames 948 over Link2 to AP2 and enters the higher capability mode. STA2 then sends the EML Operating Mode Notification frame 950 to AP2 to disable the EMLSR mode over Link1 and Link2 and receives an Ack frame 952 in response from AP2. STA1 and STA2 disable the EMLSR mode at the end of the transition timeout 954 interval; and STA1 may then transition to power save mode 956.

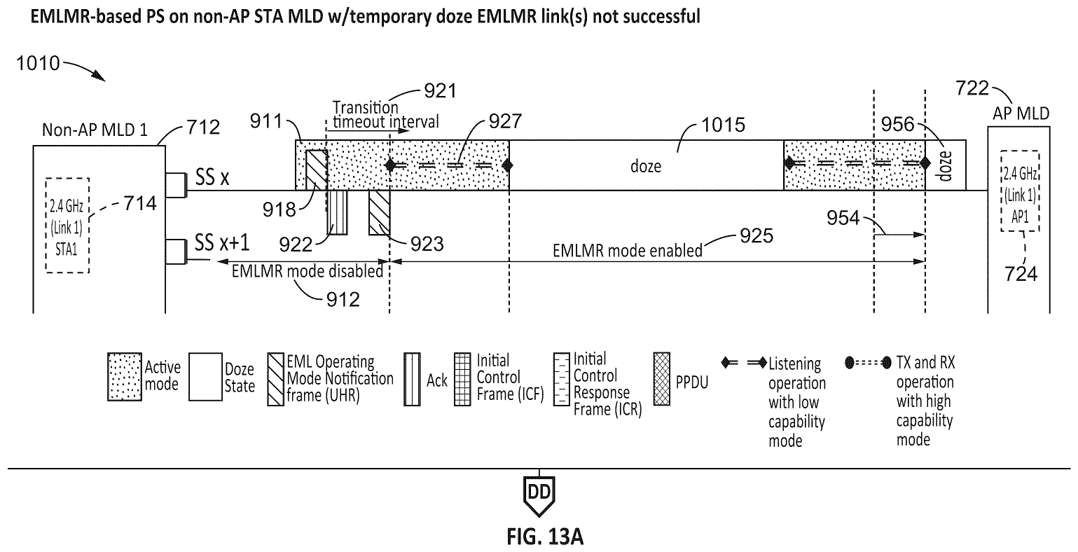

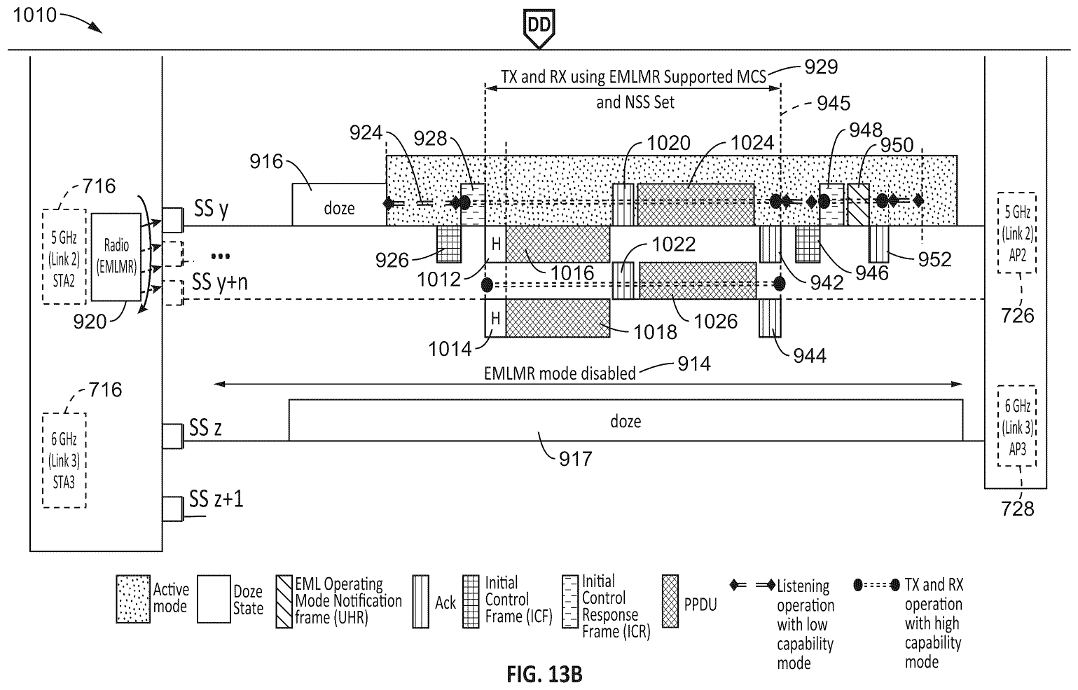

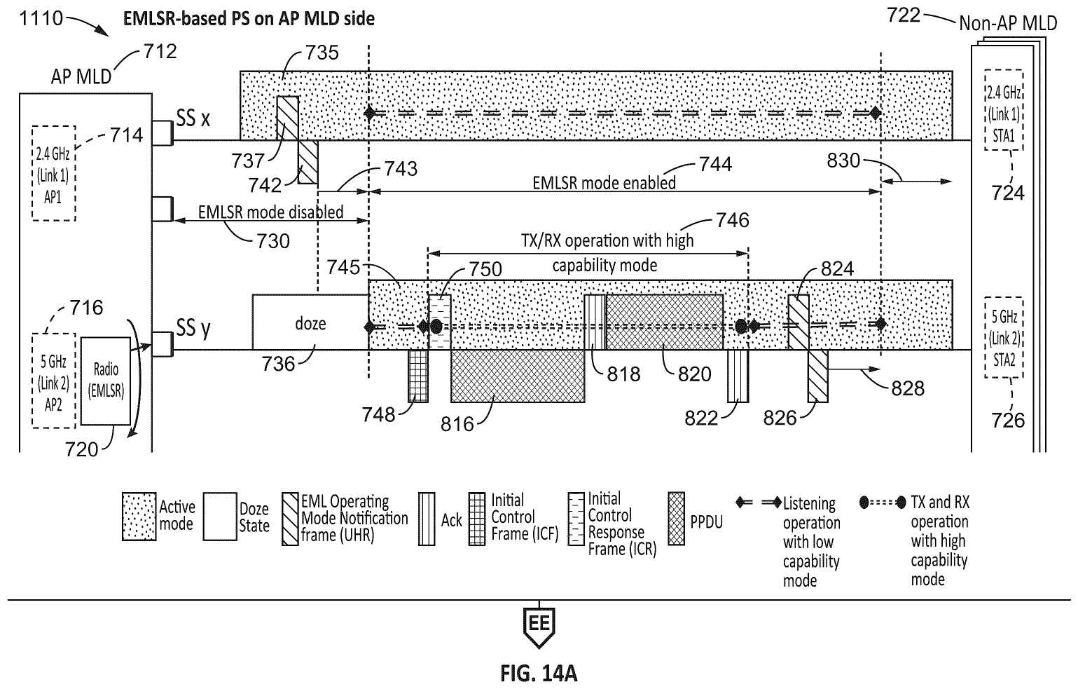

FIG. 13A and FIG. 13B illustrate an example 1010 of EMLMR-based PS on non-AP STA MLD side with temporary dozing EMLMR link(s).

A non-AP MLD 712 is shown with STA1 (Link1) 714, STA2 (Link2) 716 and STA3 (Link3) 718, shown working through EMLMR 920, which is communicating to AP MLD 722 having AP1 (Link1) 724, AP2 (Link2) 726, and AP3 (Link3) 728. STA2 and STA3 have EMLMR mode disabled 912, 914, and are in a dozing state 916, 917.

The non-AP MLD1 supports operations in the EMLMR mode on the EMLMR Links including Link1, Link2 and Link3.

STA1 is in active mode 911, and transmits an EML Operating Mode Notification frame 918 and receives an Ack 922 from AP1, after which an EML Operating Mode Notification frame 923 is received from AP1 to confirm the mode switch at the AP MLD to STA1. It will be noted that EML Operating Mode Notification frame 918 enables the EMLMR mode on Link1 and Link2 (with the duration of the EMLMR mode shown 925) and indicates MCS, NSS for Transmit and Receive on any EMLMR link after responding to the initial frame.

The non-AP MLD 1 transitions to the EMLMR mode on EMLMR Link1 and EMLMR Link2 immediately after receiving the EML Operating Mode Notification frame from AP1, which is before transition timer 921 expires. Link1 and Link2 are then shown both in active listening operation 924, 927 in the lower capability mode. The EMLMR mode is not enabled 914 on Link3 and STA3 remains in the dozing state 917 on Link3.

During the listening mode over Link2, STA2 receives the ICF frame 926 from AP2 and responds with ICR response frames 928 over link2 to AP2 and enters the higher capability mode. Immediately after STA2 sends the ICR frame, it processes the NSS switch from the other EMLMR Link(s) to the EMLMR Link2, with for example a number of spatial streams up to ‘n’ in this example. Then STA2 performs transmissions and receptions using EMLMR supported MCS and NSS set 929. STA2 receives and transmits PPDUs with the number of spatial streams of ‘n’ on Link2. Blocks 1012, 1014 are marked with an ‘H’ to indicate they are headers of PPDU 1016, 1018. STA1 is exemplified as switching to doze mode 1015 on Link1 once STA2 has identified, after the exchange of the ICF and ICR frames on Link2, the (e.g., NAV) duration of the PPDU or the TXOP that is indicated frame header of the received frame or estimated based on the buffered PPDU. A frame exchange is seen in which STA2 receives and transmits PPDUs (e.g., 1012, 1014, 1016, 1018, 1024, 1026), and transmits and receives Acks (e.g., 1020, 1022, 942, 944) with the number of spatial streams of ‘n’ on Link2.

At the end of these exchanges STA1 can switch 945 from doze mode back to active mode on Link1 after STA2 identified that the PPDUs or the TXOP has been completed on Link2. The non-AP MLD performs the NSS switch from the EMLMR link on which the ICF was received from other EMLMR link(s).

After the end of the frame exchange sequence, STA2 performs the NSS switch from EMLMR Link 2 to other EMLMR link(s). STA1 and STA2 process listening operation with lower capability mode.

During listening mode with lower capability over Link2, STA2 receives the ICF frame 946 from AP2 and responds with ICR response frames 948, over link2 to AP2 with higher capability mode. STA2 sends the EML Operating Mode Notification frame 950 to AP2 to disable the EMLSR mode over Link1 and Link2 and receives an Ack frame 952 as the response from AP2. STA1 and STA2 disable the EMLSR mode at the end of the transition timeout interval 954. Then, STA1 may then transition 954 to power save mode, with STA1 exemplified as being in doze mode 956.

### 9.3. EMLSR-Based PS on AP MLD Side

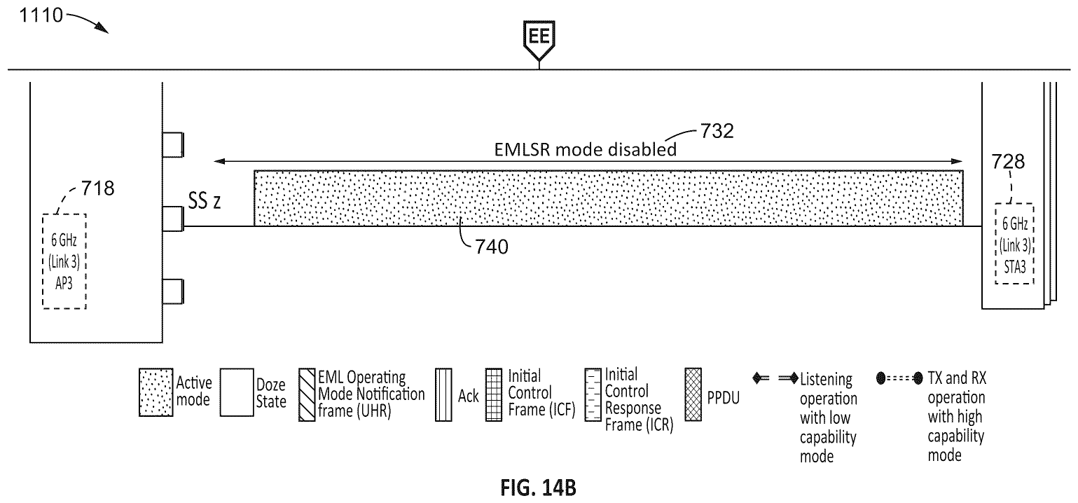

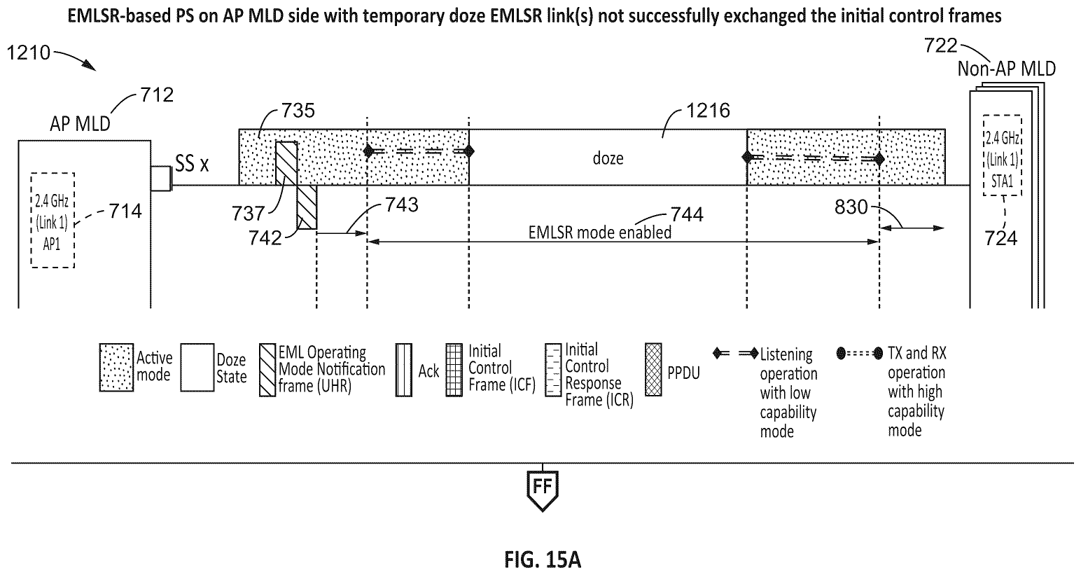

FIG. 14A and FIG. 14B illustrate an example 1110 of EMLSR-based PS on AP MLD side. The AP MLD is associated with multiple non-AP MLDs.

A non-AP MLD 712 is shown with STA1 (Link1) 714, STA2 (Link2) 716 and STA3 (Link3) 718, shown working through EMLSR 720, which is communicating to AP MLD 722 having AP1 (Link1) 724, AP2 (Link2) 726, and AP3 (Link3) 728. The AP MLD supports operation in the EMLSR mode on the EMLSR Links including Link1, Link2 and Link3.

In the figure it is initially seen that Link1 of AP1 is active 735 on Link1 with its second link having EMLSR mode disabled 730. AP2 Link1 is in dozing 736 state, while AP3 is in active mode 740, but has EMLSR mode disabled 732.

AP1 is shown broadcasting the EML Operating Mode Notification frame 737 to enable the EMLSR mode on Link1 and Link2 and receives a response frame 742 that carries EML Operation Mode Notification from multiple STAs to confirm the mode switch at the non-AP STAs to the AP.

AP2, affiliated with the AP MLD operating on the corresponding EMLSR Link2 but which did not transmit the EML Operating Mode Notification frame, transitions to active mode 745 without being required to transmit a frame with the Power Management subfield set to 0, at the end of the transition timeout interval 743.

AP3 affiliated with the AP MLD operating on the corresponding EMLSR Link3, which did not transmit the EML Operating Mode Notification frame, shall continue operating in active state 740, since the EMLSR mode is disabled on Link3 as indicated in the exchanged EML Operating Mode Notification frames on Link 1.

After the EMLSR Mode is enabled 744 on Link1 and Link2, then AP1 and AP2 process listening operations in the lower capability mode. During this listening mode over Link2, AP2 receives the ICF frame 748 from STA2 affiliated with non-AP MLD and responds with ICR frames 750 over Link2. After receiving ICF frame 748, AP2 switches to higher capability mode 746 and can exchange frames (e.g., PPDU and Acks) 816, 818, 820 and 822 with STA2 over Link2 in this higher capability mode (e.g., operating BW, NSS and MCSs, with at least one value of these parameters that indicates higher capability than that in the lower power capability mode). During the frame exchanges, STA1 and other STAs associated with AP1 on Link1 shall not transmit frames to AP1 on Link1.

After the successful exchange of EML Operating Mode Notification frames between AP2 and associated STAs on Link2 to disable the EMLSR mode over Link1 and Link2, AP1 and AP2 exchange EML operating mode notification frames 824, 826 which disables 830 the EMLSR mode at the end of the transition timeout interval 828, after which active mode ends.

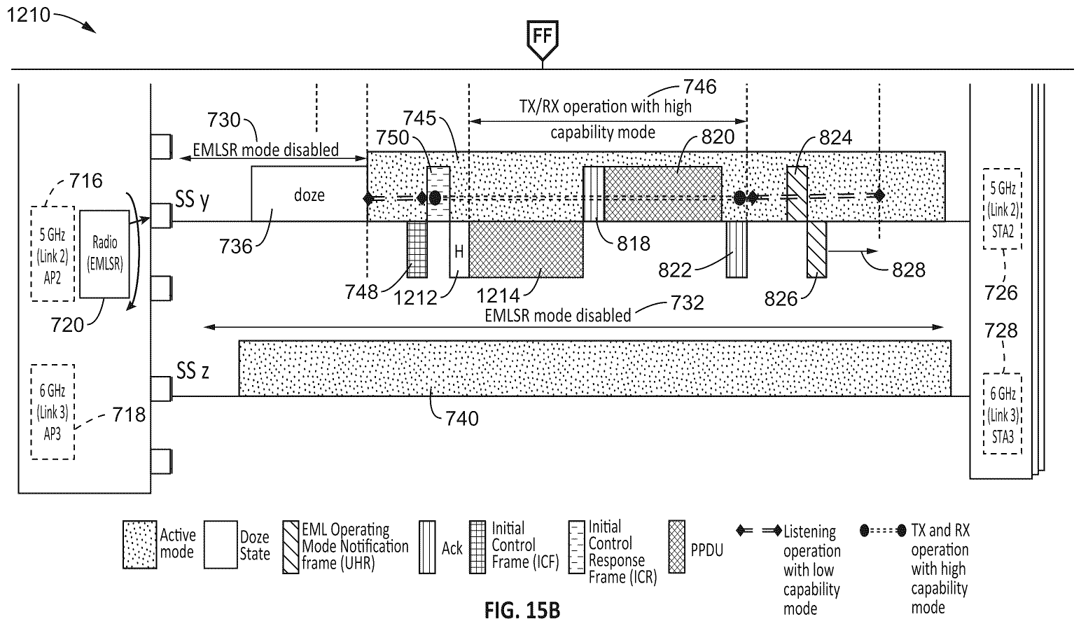

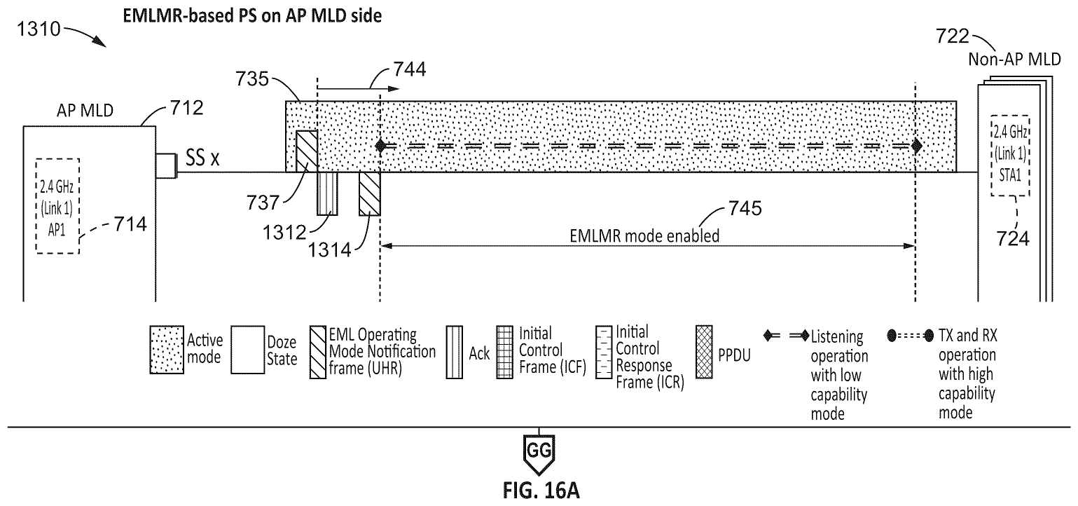

FIG. 15A and FIG. 15B illustrate an example 1210 EMLSR-based PS on AP MLD side with temporarily dozing EMLSR link(s).

A non-AP MLD 712 is shown with STA1 (Link1) 714, STA2 (Link2) 716 and STA3 (Link3) 718, shown working through EMLSR 720, which is communicating to AP MLD 722 having AP1 (Link1) 724, AP2 (Link2) 726, and AP3 (Link3) 728. The AP MLD is associated with multiple non-AP MLDs, and supports operations in the EMLSR mode on EMLSR Links including Link1, Link2 and Link3.

Initially it can be seen that Link1 of AP1 is active 735 on Link1 with its second link having EMLSR mode disabled 730. AP2 Link1 is in dozing state 736, while AP3 is in active mode 740, but has EMLSR mode disabled 732.

AP1 of the AP MLD successfully broadcasts the EML Operating Mode Notification frame 737 to enable the EMLSR mode 744 on Link1 and Link2 and receives a response frame 742 that carries an EML Operation Mode Notification from multiple STAs to confirm the mode switch at the non-AP STAs to the AP.

AP2 affiliated with the AP MLD operating on the corresponding EMLSR Link2, which did not transmit the EML Operating Mode Notification frame, transitions to active mode 745 at the end of the transition timeout interval 743 without being required to transmit a frame with the Power Management subfield set to 0.

AP3 affiliated with the AP MLD operating on the corresponding EMLSR Link3, which did not transmit the EML Operating Mode Notification frame, continues operating in the active state 740, since the EMLSR mode is disabled 732 on Link3 as indicated in the exchanged EML Operating Mode Notification frames on Link1.

After the EMLSR Mode is enabled on Link1 and Link2, AP1 and AP2 process listening operations in the lower capability mode. During listening mode in the lower capability over Link2, AP2 receives the ICF frame 748 from STA2 and responds with ICR response frames 750 over Link2. Then, AP1 Link1 goes into a dozing state 1216, and in the higher capability mode 746, AP2 can exchange frames 1212, 1214, 820, and receive associated Acks 818, 822 with STA2 over Link2 in the higher capability mode.

During the frame exchanges, STA1 and other non-AP STAs associated with AP1 on Link1 shall not transmit frames to AP1 on Link1, AP1 can switch to dozing mode on Link1 once AP2 has identified, after the exchange of the ICF and ICR frames on Link2, the (e.g., NAV) duration of the PPDU or the TXOP that is indicated in the frame header of the received frame or estimated based on the buffered PPDU. AP1 can switch from doze mode back to active mode on Link1 after AP2 identified the PPDU or the TXOP finished on Link2.

After the successful exchange of EML Operating Mode Notification frames 824, 826 between AP2 and the non-AP STAs associated with AP2 on Link2 to disable 832 the EMLSR mode over Link1 and Link2, AP1 and AP2 disable the EMLSR mode at the end of the transition timeout interval 828.

### 9.4. EMLMR-Based PS on AP MLD Side

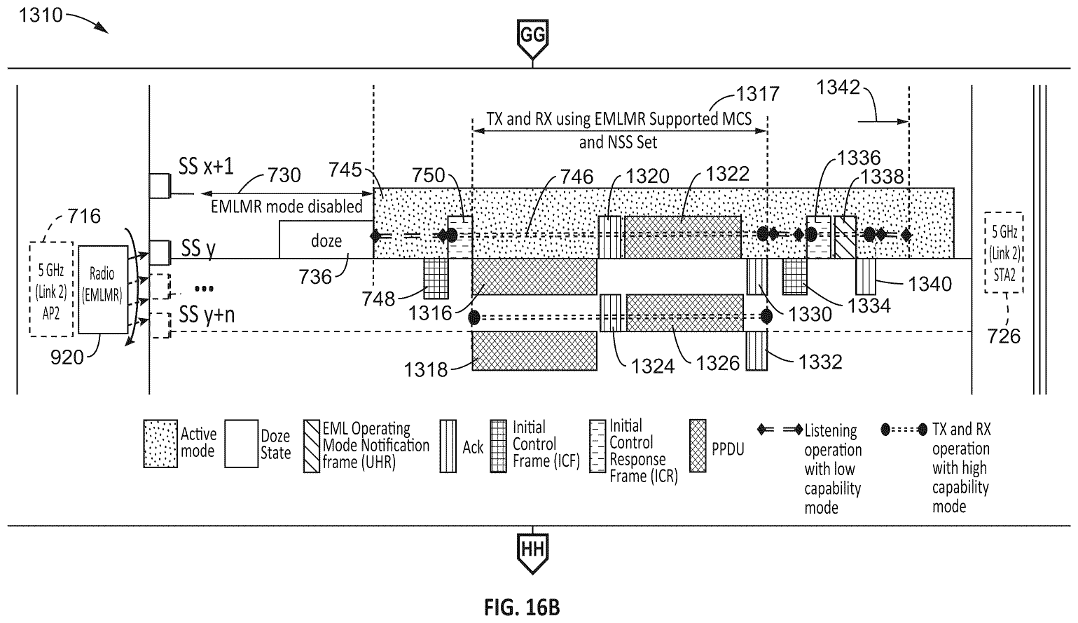

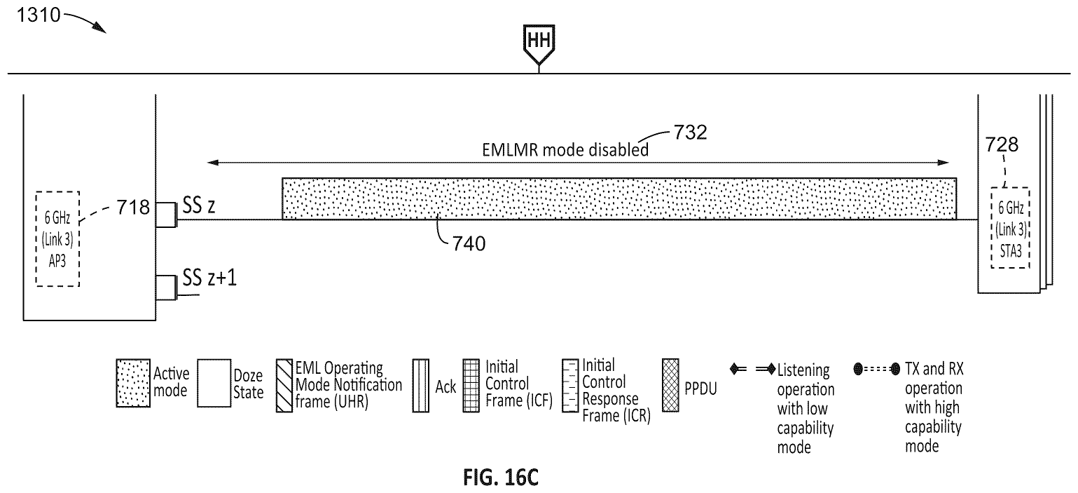

FIG. 16A through FIG. 16C illustrate an example 1310 of EMLMR-based PS on AP MLD side.

A non-AP MLD 712 is shown with STA1 (Link1) 714, STA2 (Link2) 716 and STA3 (Link3) 718, shown working through EMLMR 920, which is communicating to AP MLD 722 having AP1 (Link1) 724, AP2 (Link2) 726, and AP3 (Link3) 728. The AP MLD supports operation in the EMLMR mode on the EMLMR Links including Link1, Link2 and Link3.

Initially it can be seen that Link1 of AP1 is active 735 on Link1 with its second link having EMLMR mode disabled 730. AP2 Link1 is in dozing state 736, while AP3 is in active mode 740, but has EMLSR mode disabled 732.

AP1 of AP MLD is in active mode 735 and successfully broadcasts the EML Operating Mode Notification frame 737 to the non-AP STAs affiliated with different non-AP MLDs on Link1 to enable the EMLMR mode on Link1 and Link2 and receives BlockAck (Ack) frame 1312 as the immediate response from multiple non-AP STAs. The non-AP STAs on Link1 receives an EML Operating Mode Notification frame from AP1 and sends an EML Operating Mode Notification frame 1314 (which may be carried in UL MU transmission) to confirm the mode switch at the non-AP MLDs to the AP MLD.

The AP MLD immediately transitions to the EMLMR mode 745 on EMLMR Link1 and EMLMR Link2 after receiving the EML Operating Mode Notification frame (may be carried in UL MU transmission) from multiple non-AP STAs, which is prior to the expiration of timeout timer 744.

The EMLMR mode is not enabled on Link3 and AP3 remains in the active state.

After the EMLMR Mode is enabled on Link1 and Link2, AP1 and AP2 process listening operations in the lower capability mode. While listening in the lower capability mode over Link2, AP2 receives an ICF frame 748 from STA2 and responds with ICR response frames 750 over Link2 to STA2 and enters the higher capability mode 746, with communications shown using EMLMR supported MCS and NSS set 1317.

Immediately after AP2 sends the ICR frame, it enters active mode 745 and processes the NSS switch from the other EMLMR Link(s) to the EMLMR Link2, and can commence using any number of spatial streams up to ‘n’ in this example. Then AP2 receives and transmits PPDUs with the number of spatial streams of ‘n’ on Link2, exemplified with transmitting frames 1316, 1318, 1322, 1326, and receiving associated Acks 1320, 1324, 1330, 1332.

After the end of the frame exchange sequence, the AP2 performs the NSS switch from EMLMR Link2 to other EMLMR link(s). AP1 and AP2 then begin processing listening operation in the lower capability mode again.

During listening mode in the lower capability over Link2, AP2 receives an ICF frame 1334 from STA2 and responds with ICR response frames 1336 over Link2 to STA2 with higher capability mode. AP2 broadcast the EML Operating Mode Notification frame 1338 to non-AP STAs on Link2 to disable the EMLSR mode over Link1 and Link2 and receives a BlockAck frame 1340 as the response from the non-AP STAs on Link 2. AP1 and AP2 disable the EMLSR mode at the end of the transition timeout interval 1342.

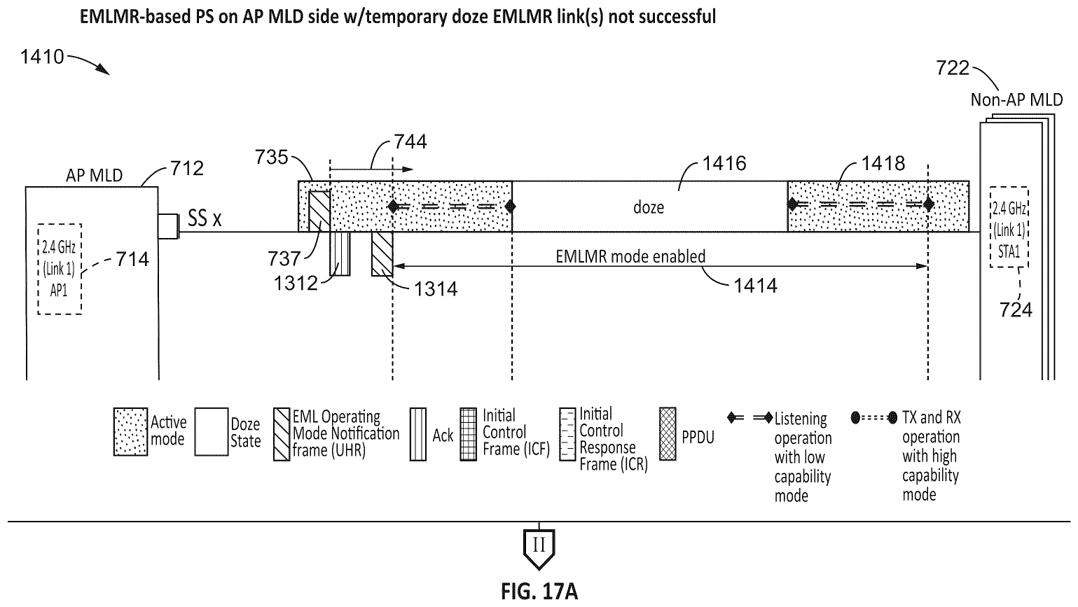

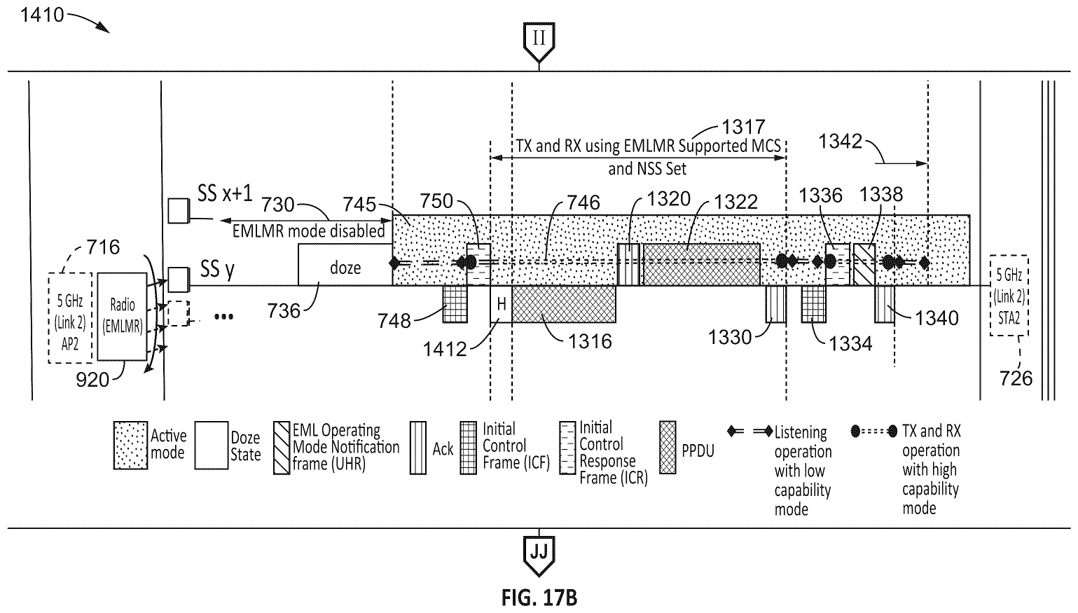

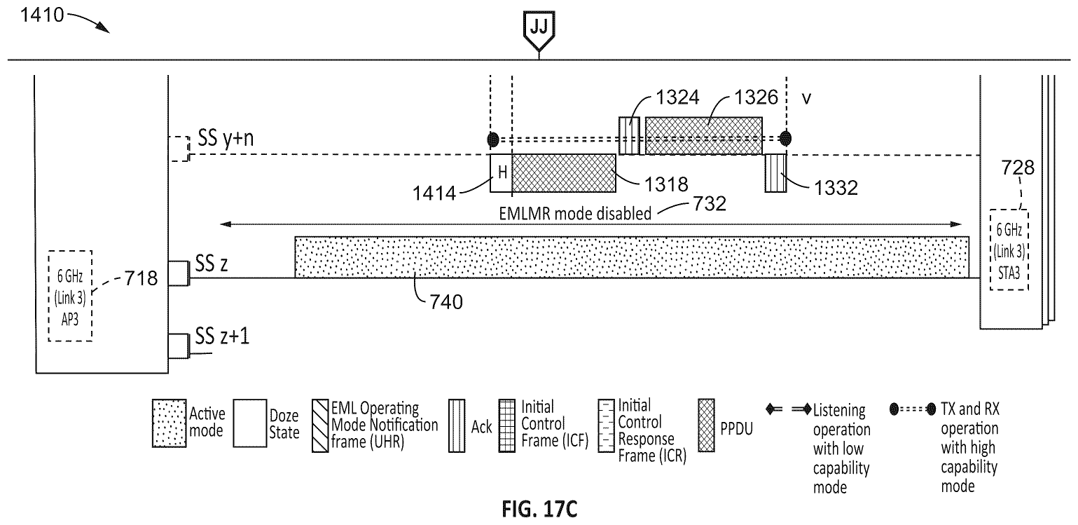

FIG. 17A through FIG. 17C illustrate an example 1410 of an EMLMR-based PS on AP MLD side with temporary dozing of EMLMR link(s).

A non-AP MLD 712 is shown with STA1 (Link1) 714, STA2 (Link2) 716 and STA3 (Link3) 718, shown working through EMLMR 920, which is communicating to AP MLD 722 having AP1 (Link1) 724, AP2 (Link2) 726, and AP3 (Link3) 728. The AP MLD supports operation in the EMLMR mode on the EMLMR Links including Link1, Link2 and Link3.

Initially it can be seen that Link1 of AP1 is active 735 on Link1 with its second link having EMLMR mode disabled 730. AP2 Link1 is in dozing state 736, while AP3 is in active mode 740, but has EMLMR mode disabled 732.

AP1 of AP MLD successfully broadcast the EML Operating Mode Notification frame 737 to non-AP STAs affiliated with different non-AP MLDs on Link 1 to enable the EMLMR mode on Link1 and Link2 and receives a BlockAck frame 1312 as the immediate response. Non-AP STAs receive an EML Operating Mode Notification frame 1314 to confirm the mode switch at the non-AP MLDs to the AP MLD.

The AP MLD transitions to the EMLMR mode 1414 on EMLMR Link1 and EMLMR Link2 immediately after receiving the EML Operating Mode Notification frame (which may be carried in UL MU transmission) from the non-AP STAs on Link1, which is before the transition timeout timer 744 expires.

The EMLMR mode is not enabled (remains disabled) on Link 3 and AP3 remains in Active status 740 on Link 3.

After the EMLMR Mode is enabled on Link1 and Link2, AP1 and AP2 perform listening operations in the active lower capability mode 1317. During listening mode in the lower capability over Link2, AP2 receives the ICF frame 748 from STA2 and responds with ICR response frames 750 over Link2 to STA2 using the higher capability mode. Immediately after AP2 sends the ICR frame, it processes the NSS switch from the other EMLMR Link(s) to the EMLMR Link2, switching to using, for example, a number of spatial streams 1317 up to ‘n’ as per this example.

Then AP2 using high capability mode 746 receives and transmits PPDUs with the number of spatial streams of ‘n’ on Link2. Block 1412 is marked with an ‘H’ to show it is the header of PPDU 1316. The example shows transmissions and Acks 1412, 1414, 1316, 1318, 1320, 1322, 1324, 1326, 1330 and 1332. At the end of the EMLMR communications 1317, then AP1 can switch to a dozing state 1416 on Link1 once AP2 has identified, after the exchange of the ICF and ICR frames on Link2, the (e.g., NAV) duration of the PPDU or the TXOP that is indicated frame header of the received frame or estimated based on the buffered PPDU. AP1 can switch from dozing mode back to active mode 1418 on Link1 after AP2 identified the PPDU or the TXOP finished on Link2.

After the end of the frame exchange sequence, the AP2 performs the NSS switch from EMLMR Link2 to other EMLMR link(s). AP1 and AP2 processing listening operation with lower capability mode again.

During listening mode with lower capability over Link 2, AP2 receives the ICF frame 1334 from STA2 and sends ICR response frames 1336 over Link2 to STA2 in the higher capability mode. AP2 broadcasts the EML Operating Mode Notification frame 1338 to disable the EMLSR mode over Link1 and Link2 and receives a BlockAck frame 1340 as the response from non-AP STAs on Link2. AP1 and AP2 disable the EMLSR mode at the end of the transition timeout 1342 interval.

9.5. EMLSR-Based PS on AP MLD Side with Isolated Radio

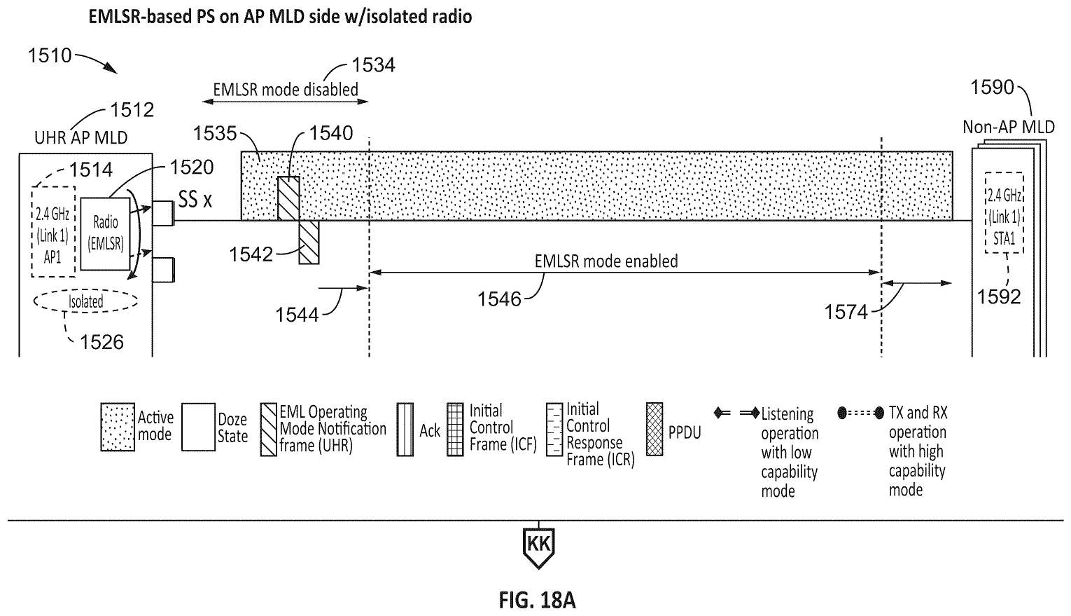

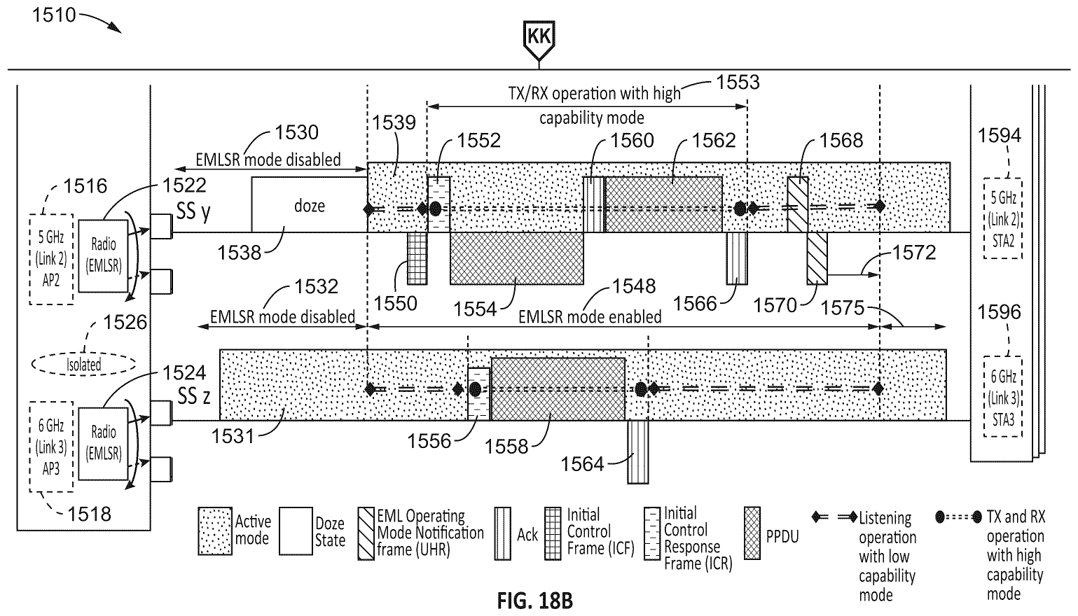

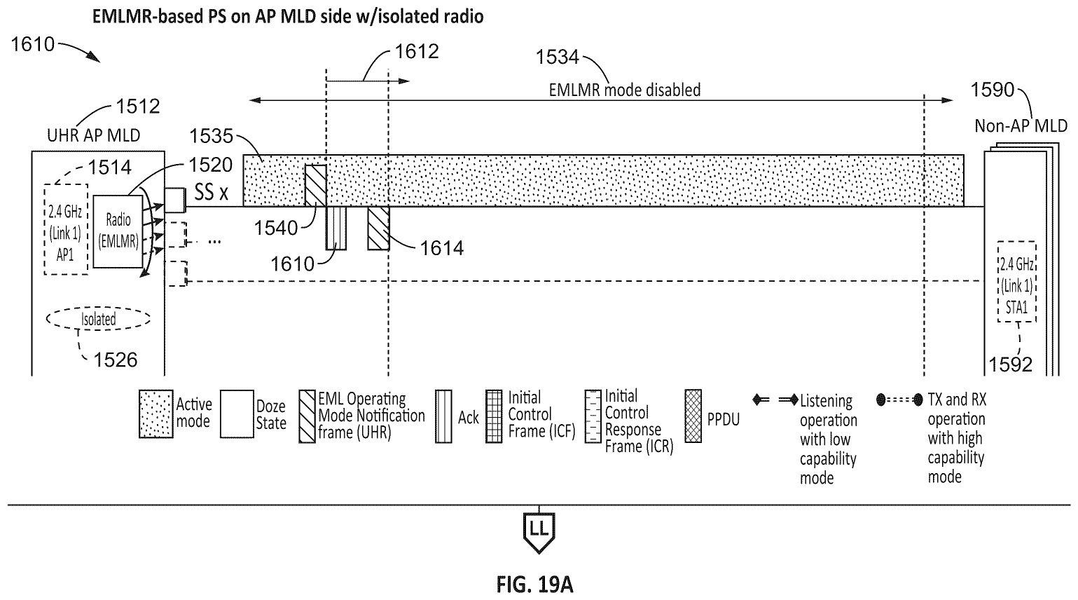

FIG. 18A and FIG. 18B illustrate an example 1510 of EMLSR-based PS on AP MLD side with the radios being isolated from one another.

A UHR AP MLD 1512 is shown with AP1 (Link1) 1514 with its EMLSR radio 1520, AP2 (Link2) 1516 with its EMLSR radio 1522, and AP3 (Link3) 1518 with its EMLSR radio 1524. Each of these radios is Radio-Frequency (RF) isolated 1526 from the other radios, thus preventing any significant signal interference. This AP MLD is communicating with a non-AP MLD 1590 having STA1 (Link1) 1592, STA2 (Link2) 1594, and STA3 (Link3) 1596.

The AP MLD is associated with multiple non-AP MLDs, and supports operations in the EMLSR mode on the EMLSR Links including Link1, Link2 and Link3. The figure depicts AP1 in an active state 1535, but with EMSLR mode disabled 1534. AP2 is initially inactive with EMSLR mode disabled 1530. AP3 is initially active 1531 with EMLSR mode disabled 1532.

AP1 of the AP MLD successfully broadcasts an EML Operating Mode Notification frame 1540 to enable the EMLSR mode on Link2 and Link3, AP2 enters dozing mode 1538. AP1 receives immediate response frames 1542 that carries EML Operation Mode Notification from multiple STAs to confirm the mode switch at the non-AP STAs to the AP. The mode switch to EMLSR mode 1546 arises after the transition timeout 1544.

AP2 affiliated with the AP MLD operating on the corresponding EMLSR Link2, which did not transmit the EML Operating Mode Notification frame, transitions from a dozing state 1538 to active mode 1539 without being required to transmit a frame with the Power Management subfield set to a value of 0, at the end of the transition timeout interval 1544 from AP1.

AP3 affiliated with the AP MLD operating on the corresponding EMLSR Link3, which did not transmit the EML Operating Mode Notification frame, continues operating in active state 1531, but now with EMLSR enabled 1548.

After the EMLSR Mode is enabled on Link2 and Link3, AP2 and AP3 process listening operations in the lower capability mode. During listening mode in the lower capability over Link2, AP2 receives an ICF frame 1550 from STA2 affiliated with non-AP MLD and AP2 transmits an ICR response frame 1552 over Link2. Then, AP2 can exchange frames with STA2 over Link2 with higher capability mode 1553, exemplified with transmissions 1554, 1562 and Acks 1560 and 1566.

During the frame exchanges, AP3 transmits an un-solicited ICR response frame 1556 to the non-AP STA(s) on Link3 in the high capability mode and then transmits the DL PPDUs 1558 to the non-AP STA(s) on Link3 and receives Ack 1564, after which it discontinues using the high capability mode and shifts back to the lower capability mode.

After a successful exchange of EML Operating Mode Notification frames 1568 1570 between AP2 and associated STAs on Link2 to disable the EMLSR mode over Link2 and Link3, AP2 and AP3 disable 1574, 1575 the EMLSR mode at the end of transition timeout interval 1572.

9.6. EMLMR-Based PS on AP MLD Side with Isolated Radio

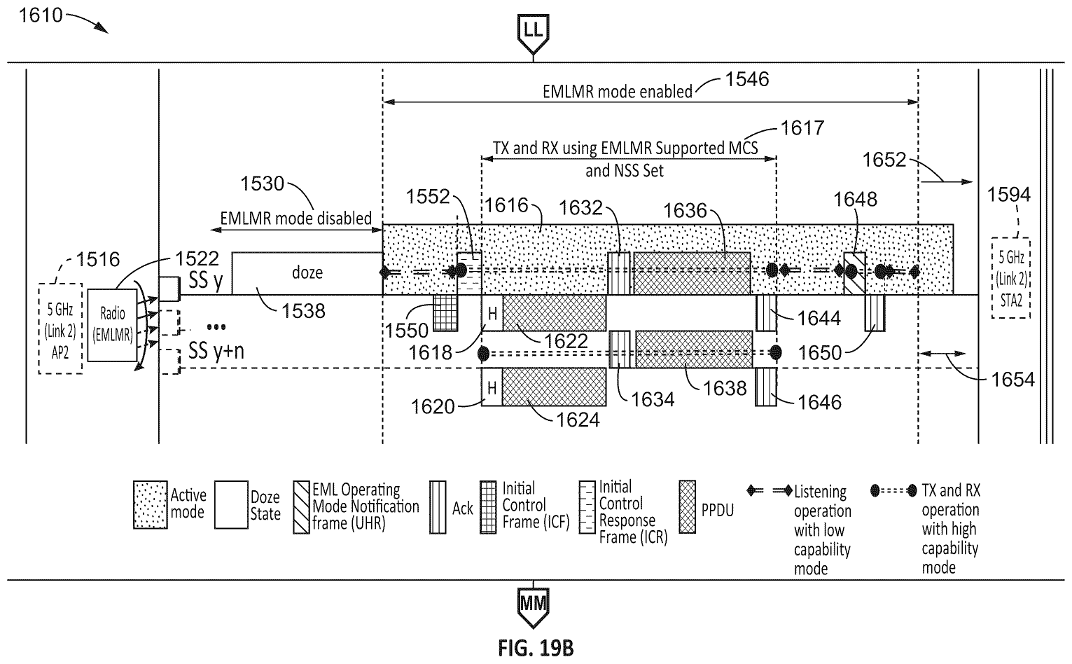

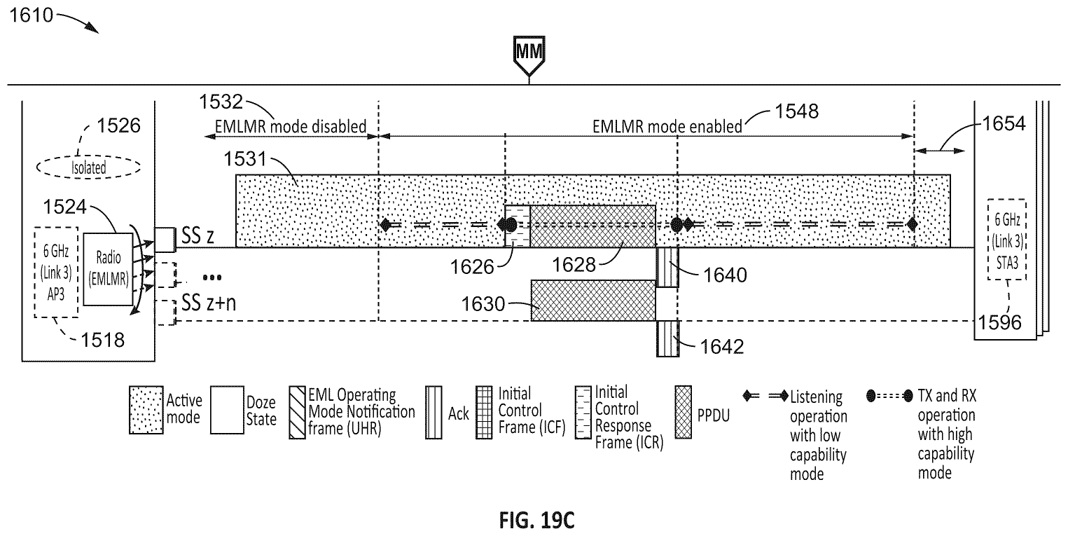

FIG. 19A through FIG. 19C illustrate an example 1610 of EMLMR-based PS on AP MLD side with the radios being Radio-Frequency (RF) isolated from one another.

A UHR AP MLD 1512 is shown with AP1 (Link1) 1514 with its EMLSR radio 1520, AP2 (Link2) 1516 with its EMLSR radio 1522, and AP3 (Link3) 1518 with its EMLSR radio 1524. Each of these radios is Radio-Frequency (RF) isolated 1526 from the other radios, thus preventing any significant signal interference. This AP MLD is communicating with a non-AP MLD 1590 having STA1 (Link1) 1592, STA2 (Link2) 1594, and STA3 (Link3) 1596.

The AP MLD supports operations in the EMLMR mode on the EMLMR Links including Link1, Link2 and Link3. The figure depicts AP1 in an active state 1535, but with EMSLR mode disabled 1534. AP2 is initially inactive in the dozing state 1538 with EMSLR mode disabled 1530. AP3 is initially active 1531 with EMLSR mode disabled 1532.

AP1 of AP MLD successfully broadcasts the EML Operating Mode Notification frame 1540 to the non-AP STAs affiliated with different non-AP MLDs on Link1 to enable the EMLSR mode on Link2 and Link3 and receives BlockAck frame 1610 as the immediate response from multiple non-AP STAs. The non-AP STAs on Link1 receiving the EML Operating Mode Notification frame 1540 from AP1, sends an EML Operating Mode Notification frame 1614 (which may be carried in UL MU transmission) to confirm the mode switch at the non-AP MLDs to the AP MLD.

The AP MLD transitions to the EMLMR mode 1546 on EMLMR Link2 and EMLMR Link3 immediately after receiving the EML Operating Mode Notification frame 1614 (may be carried in UL MU transmission) from multiple non-AP STAs, which is before the transition timeout timer 1612 expires, and at this same time AP2 transitioned from dozing state 1538 to active mode 1616, and EMLMR mode 1548 was entered by AP3,

The EMLMR mode is not enabled on Link1 and AP1 remains in the active state on Link1.

After the EMLMR Mode is enabled on Link2 and Link3, AP2 and AP3 process listening operations in the lower capability mode.

During listening mode in the lower capability mode over Link2, AP2 receives an ICF frame 1550 from STA2 and then transmits ICR response frames 1552 over Link2 to STA2 in the higher capability mode. Immediately after AP2 sends ICR frame 1550, it processes the NSS switch 1617 from the other EMLMR Link(s) to the EMLMR Link2, using for example a number of spatial streams up to ‘n’ in this example. Then AP2 receives and transmits PPDUs and Acks, 1618, 1620, 1622, 1624, 1632, 1634, 1636, 1638, 1644, 1646 with the number of spatial streams of ‘n’ on Link2.

During the frame exchange between AP2 and STA2 on Link 2, AP3 transitions to high capability mode and transmits an un-solicited ICR response frame 1626 to the non-AP STA(s) on Link3. AP3 then transmits the DL PPDUs 1628, 1630 to the non-AP STA(s) and receives Ack/block ack frames 1640, 1642 on Link3.

After the end of the frame exchange sequences, AP2 and AP3 perform an NSS switch from EMLMR Link2 and EMLMR Link3 to other EMLMR link(s). AP2 and AP3 return to processing listening operations in the lower capability mode again.

During listening mode in the lower capability over Link2, AP2 transitions to high capability mode and broadcasts the EML Operating Mode Notification frame 1648 to non-AP STAs on Link2 to disable the EMLSR mode over Link2 and Link3 and receives a BlockAck frame 1650 as the response from the non-AP STAs on Link2. AP2 and AP3 disable the EMLSR mode at the end of the transition timeout interval 1652, 1654.

### 10. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A multiple link device apparatus for communication in a wireless network while providing dynamic power saving (PS), the apparatus comprising: (a) a multiple link device (MLD) comprising multiple stations (STAs); (b) wherein either the STAs of the MLD are coupled to a single radio (SR), or each STA of the MLD is coupled to a separate radio in a multiple radio (MR) configuration providing enhanced multi-link (EML) communications, as EML (SR) or EML (MR); (c) wherein all said STAs of the MLD are either access point (AP) STAs or non-AP STAs; (d) at least one processor of said MLD and a non-transitory memory storing instructions executable by the at least one processor for wirelessly communicating from the STAs of said MLD with other STAs on an IEEE 802.11 wireless local area network (WLAN); and (e) wherein said instructions, when executed by the at least one processor, perform steps of a wireless communications protocol, comprising: (e)(i) wherein said STA, and the other STAs of the MLD, can be in either a dozing state and thus asleep, or in an active state; (e)(ii) wherein said active state comprises both a fully powered state in which it can transmit and/or receive in a higher powered active state (higher power active mode), and a lower powered active state (lower power active mode) in which it is capable of only listening; (e)(iii) directing one or more of the STAs of said MLD to listen on the enabled EML(SR/MR) link(s) using the lower power active mode; and (e)(iv) transitioning to the higher power active mode for transmitting frames with another MLD.

A multiple link device apparatus for communication in a wireless network while providing dynamic power saving (PS), the apparatus comprising: (a) a multiple link device (MLD) comprising multiple stations (STAs); (b) wherein either the STAs of the MLD are coupled to a single radio (SR), or each STA of the MLD is coupled to a separate radio in a multiple radio (MR) configuration providing enhanced multi-link (EML) communications, as EML (SR) or EML (MR); (c) wherein all said STAs of the MLD are either access point (AP) STAs or non-AP STAs; (d) at least one processor of said MLD and a non-transitory memory storing instructions executable by the at least one processor for wirelessly communicating from the STAs of said MLD with other STAs on an IEEE 802.11 wireless local area network (WLAN); and (e) wherein said instructions, when executed by the at least one processor, perform steps of a wireless communications protocol, comprising: (e)(i) wherein said STA, and the other STAs of the MLD, can be in either a dozing state and thus asleep, or in an active state; (e)(ii) wherein said active state comprises both a fully powered state in which it can transmit and/or receive in a higher powered active state (higher power active mode), and a lower powered active state (lower power active mode) in which it is capable of only listening; (e)(iii) directing one or more of the STAs of said MLD to listen on the enabled EML(SR/MR) link(s) using the lower power active mode; (e)(iv) transitioning to the higher power active mode for transmitting frames with another MLD; and (e)(v) wherein transitioning from lower power active mode to the higher power active mode is initiated by an exchange of initial control frame (ICF) and initial control response frame (ICR), or a transmission of an unsolicited ICR frame.

A method of performing dynamic power savings (PS) between multiple link devices operating over a wireless network while providing dynamic power saving (PS), comprising: (a) communicating between multiple link devices (MLD), which each have multiple stations (STAs), wherein either the STAs of the MLD are coupled to a single radio (SR), or each STA of the MLD is coupled to a separate radio in a multiple radio (MR) configuration providing enhanced multi-link (EML) communications, as EML (SR) or EML (MR); (b) performing a wireless communications protocol for wirelessly communicating from the STAs of said MLD with other STAs on an IEEE 802.11 wireless local area network (WLAN); and (c) wherein said STA, and the other STAs of the MLD, can be in either a dozing state and thus asleep, or in an active state; (d) wherein said active state comprises both a fully powered state in which it can transmit and/or receive in a higher powered active state (higher power active mode), and a lower powered active state (lower power active mode) in which it is capable of only listening; (e) directing one or more of the STAs of said MLD to listen on the enabled EML(SR/MR) link(s) using the lower power active mode; and (f) transitioning to the higher power active mode for transmitting frames with another MLD.

The apparatus or method of any preceding implementation, wherein higher power active mode provides enhanced capability over the lower power active mode, in regard to at least one of the following characteristics selected from the group of communication parameters consisting of bandwidth (BW), use of single spatial stream (SS) or number of spatial stream (NSS), limited data rates, communication data format.

The apparatus or method of any preceding implementation, wherein said communication data format is for encoding a physical layer convergence protocol (PLCP) protocol data unit (PPDU) format.

The apparatus or method of any preceding implementation, wherein said communication data format comprises multiple modulation and coding sets (MCSs).

The apparatus or method of any preceding implementation, wherein one or more STAs of said MLD transition to a dozing state on their associated EML(SR/MR) links when other STAs on said MLD is operating in the higher power active mode communicating on another EML(SR/MR) mode enabled link.

The apparatus or method of any preceding implementation, wherein transitioning from lower power active mode to the higher power active mode is initiated by an exchange of initial control frame (ICF) and initial control response frame (ICR), or a transmission of an unsolicited ICR frame.

The apparatus or method of any preceding implementation, wherein said ICF frame comprises a pre-frame check sequence (pre-FCS) field which precedes an FCS field at the end of the frame, whereby a receiver of the ICF frame commences all actions corresponding to this ICF frame after decoding the pre-FCS field instead of waiting until the FCS field of the ICF frame is processed.

The apparatus or method of any preceding implementation, wherein said pre-FCS field is contained in the medium access control (MAC) header of the ICF frame.

The apparatus or method of any preceding implementation, wherein a padding field of sufficient length is contained in the ICF frame to at least equal the switch delay time required when transitioning from the power mode to the higher power mode.

The apparatus or method of any preceding implementation, wherein said MLD is coupled through a backhaul connection to a central controller which provides cooperation between MLDs.

The apparatus or method of any preceding implementation, wherein the functions of said at least one processor of said MLD are shared between said MLD and the central controller.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to 5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A multiple link device apparatus for communication in a wireless network while providing dynamic power saving (PS), the apparatus comprising:
(a) a multiple link device (MLD) comprising multiple stations (STAs);
(b) wherein either the STAs of the MLD are coupled to a single radio (SR), or each STA of the MLD is coupled to a separate radio in a multiple radio (MR) configuration providing enhanced multi-link (EML) communications, as EML (SR) or EML (MR);
(c) wherein all said STAs of the MLD are either access point (AP) STAs or non-AP STAs;
(d) at least one processor of said MLD and a non-transitory memory storing instructions executable by the at least one processor for wirelessly communicating from the STAs of said MLD with other STAs on an IEEE 802.11 wireless local area network (WLAN); and
(e) wherein said instructions, when executed by the at least one processor, perform steps of a wireless communications protocol, comprising:
(i) wherein said STA, and the other STAs of the MLD, can be in either a dozing state and thus asleep, or in an active state;
(ii) wherein said active state comprises both a fully powered state in which it can transmit and/or receive in a higher powered active state (higher power active mode), and a lower powered active state (lower power active mode) in which it is capable of only listening;
(iii) directing one or more of the STAs of said MLD to listen on the enabled EML(SR/MR) link(s) using the lower power active mode; and
(iv) transitioning to the higher power active mode for transmitting frames with another MLD.

2. The apparatus of claim 1, wherein higher power active mode provides enhanced capability over the lower power active mode, in regard to at least one of the following characteristics selected from the group of communication parameters consisting of bandwidth (BW), use of single spatial stream (SS) or number of spatial stream (NSS), limited data rates, communication data format.

3. The apparatus of claim 2, wherein said communication data format is for encoding a physical layer convergence protocol (PLCP) protocol data unit (PPDU) format.

4. The apparatus of claim 2, wherein said communication data format comprises multiple modulation and coding sets (MCSs).

5. The apparatus of claim 1, wherein one or more STAs of said MLD transition to a dozing state on their associated EML(SR/MR) links when other STAs on said MLD is operating in the higher power active mode communicating on another EML(SR/MR) mode enabled link.

6. The apparatus of claim 1, wherein transitioning from lower power active mode to the higher power active mode is initiated by an exchange of initial control frame (ICF) and initial control response frame (ICR), or a transmission of an unsolicited ICR frame.

7. The apparatus of claim 6, wherein said ICF frame comprises a pre-frame check sequence (pre-FCS) field which precedes an FCS field at the end of the frame, whereby a receiver of the ICF frame commences all actions corresponding to this ICF frame after decoding the pre-FCS field instead of waiting until the FCS field of the ICF frame is processed.

8. The apparatus of claim 7, wherein said pre-FCS field is contained in the medium access control (MAC) header of the ICF frame.

9. The apparatus of claim 6, wherein a padding field of sufficient length is contained in the ICF frame to at least equal the switch delay time required when transitioning from the power mode to the higher power mode.

10. The apparatus of claim 1, wherein said MLD is coupled through a backhaul connection to a central controller which provides cooperation between MLDs.

11. The apparatus of claim 10, wherein the functions of said at least one processor of said MLD are shared between said MLD and the central controller.

12. A multiple link device apparatus for communication in a wireless network while providing dynamic power saving (PS), the apparatus comprising:
(a) a multiple link device (MLD) comprising multiple stations (STAs);
(b) wherein either the STAs of the MLD are coupled to a single radio (SR), or each STA of the MLD is coupled to a separate radio in a multiple radio (MR) configuration providing enhanced multi-link (EML) communications, as EML (SR) or EML (MR);
(c) wherein all said STAs of the MLD are either access point (AP) STAs or non-AP STAs;
(d) at least one processor of said MLD and a non-transitory memory storing instructions executable by the at least one processor for wirelessly communicating from the STAs of said MLD with other STAs on an IEEE 802.11 wireless local area network (WLAN); and
(e) wherein said instructions, when executed by the at least one processor, perform steps of a wireless communications protocol, comprising:
(i) wherein said STA, and the other STAs of the MLD, can be in either a dozing state and thus asleep, or in an active state;
(ii) wherein said active state comprises both a fully powered state in which it can transmit and/or receive in a higher powered active state (higher power active mode), and a lower powered active state (lower power active mode) in which it is capable of only listening;
(iii) directing one or more of the STAs of said MLD to listen on the enabled EML(SR/MR) link(s) using the lower power active mode;
(iv) transitioning to the higher power active mode for transmitting frames with another MLD; and
(v) wherein transitioning from lower power active mode to the higher power active mode is initiated by an exchange of initial control frame (ICF) and initial control response frame (ICR), or a transmission of an unsolicited ICR frame.

13. The apparatus of claim 12, wherein said ICF frame comprises a pre-frame check sequence (pre-FCS) field which precedes an FCS field at the end of the frame, whereby a receiver of the ICF frame commences all actions corresponding to this ICF frame after decoding the pre-FCS field instead of waiting until the FCS field of the ICF frame is processed.

14. The apparatus of claim 13, wherein said pre-FCS field is contained in the medium access control (MAC) header of the ICF frame.

15. The apparatus of claim 12, wherein a padding field of sufficient length is contained in the ICF frame to at least equal the switch delay time required when transitioning from the power mode to the higher power mode.

16. The apparatus of claim 12, wherein higher power active mode provides enhanced capability over the lower power active mode, in regard to at least one of the following characteristics selected from the group of communication parameters consisting of bandwidth (BW), use of single spatial stream (SS) or number of spatial stream (NSS), limited data rates, communication data format.

17. The apparatus of claim 16, wherein said communication data format is for encoding a physical layer convergence protocol (PLCP) protocol data unit (PPDU) format.

18. The apparatus of claim 16, wherein said communication data format comprises multiple modulation and coding sets (MCSs).

19. The apparatus of claim 1, wherein said MLD is coupled through a backhaul connection to a central controller which provides cooperation between MLDs.

20. A method of performing dynamic power savings (PS) between multiple link devices operating over a wireless network while providing dynamic power saving (PS), comprising:
(a) communicating between multiple link devices (MLD), which each have multiple stations (STAs), wherein either the STAs of the MLD are coupled to a single radio (SR), or each STA of the MLD is coupled to a separate radio in a multiple radio (MR) configuration providing enhanced multi-link (EML) communications, as EML (SR) or EML (MR);
(b) performing a wireless communications protocol for wirelessly communicating from the STAs of said MLD with other STAs on an IEEE 802.11 wireless local area network (WLAN); and
(c) wherein said STA, and the other STAs of the MLD, can be in either a dozing state and thus asleep, or in an active state;
(d) wherein said active state comprises both a fully powered state in which it can transmit and/or receive in a higher powered active state (higher power active mode), and a lower powered active state (lower power active mode) in which it is capable of only listening;
(e) directing one or more of the STAs of said MLD to listen on the enabled EML(SR/MR) link(s) using the lower power active mode; and
(f) transitioning to the higher power active mode for transmitting frames with another MLD.
